(19) United States
(12) Patent Application Publication
(10) Pub. No.: US 2024/0059839 A1
(43) Pub. Date: Feb. 22, 2024

(54) Optically Transparent Polyimide

(71) Applicant: Sumitomo Chemical Company, Limited, Tokyo (JP)

(72) Inventors: Kelby Hull, Oakland, CA (US); Arjan Zoombelt, Truckee, CA (US)

(73) Assignee: Sumitomo Chemical Company, Limited, Tokyo (JP)

(21) Appl. No.: 18/265,635

(22) PCT Filed: Dec. 6, 2021
(86) PCT No.: PCT/US2021/072757

§ 371 Date: Jun. 7, 2023

Related U.S. Application Data
(60) Provisional application No. 63/122,765, filed on Dec. 8, 2020.

(51) Int. Cl. C08G 73/10; C08J 5/18

(52) U.S. Cl. CPC C08G 73/1021; C08G 73/1039; C08G 73/1042; C08G 73/1053; C08J 5/18; C08J 2379/08

(57) ABSTRACT

A polyimide material includes a polyimide of Formula (I)

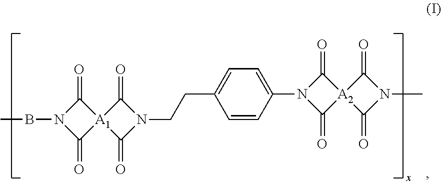

wherein A₁ and A₂ for each occasion independently are selected from a group of tetravalent moieties and B for each occasion independently is selected from a group of divalent moieties, wherein x is an integer greater than 1. The polyimide material has desirable optical, structural, thermal, mechanical properties, or combination thereof.

### TECHNICAL FIELD

The present disclosure relates to optically transparent polyimides comprising at least one asymmetric di-imido component.

### BACKGROUND ART

Organic films are high in flexibility as compared to glass, difficult to break, and lightweight. Recently, study has been performed with the aim of developing a flexible display using organic film as the substrate of a flat panel display.

Generally, resins used in organic film include polyester, polyamide, polyimide, polycarbonate, polyether sulfone, acrylic, and epoxy. Of these, polyimide resin is high in heat resistance, mechanical strength, abrasion resistance, dimensional stability, chemical resistance, insulation capability, and accordingly in wide use in the electric/electronic industries.

For use as an alternative to the glass substrate in display elements, polyimide resin is required to have high transparency and low birefringence. These properties are necessary to obtain clear images. However, manufacturing methods provide inconsistencies in resins leading to variation in performance properties. Accordingly, there is a need for devising and improving processes that lead to performance consistency.

### SUMMARY

Various aspects and embodiments contemplated herein may include, but are not limited to one or more of the following.

In a first aspect, a polyimide material comprises a polyimide of Formula (I):

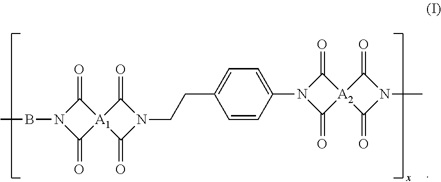

The moieties A₁ and A₂, for each occasion independently, can be selected from a group of tetravalent moieties. The moiety B, for each occasion independently, can be selected from a group of divalent moieties. The parameter x can be an integer greater than 1.

The polyimide material has at least one property selected from the following property group M. The polyimide can have at least one property selected from the following property group O.

The property group M refers to structural, thermal, or mechanical properties and can include:
(i) a tensile strength as determined according to ASTM standard D897-08 of at least 2.5 GPa, at least 2.8 GPa, at least 3.0 GPa, at least 3.3 GPa, at least 3.5 GPa, at least 3.8 GPa, at least 4.0 GPa, at least 4.3 GPa, at least 4.5 GPa, at least 4.8 GPa, or at least 5.0 GPa;
(ii) a glass transition temperature as determined by thermomechanical analysis of at least 180° C., at least 185° C., at least 190° C., at least 195° C., at least 200° C., at least 205° C., at least 210° C., at least 215° C., at least 220° C., at least 225° C., at least 230° C., at least 235° C., at least 240° C., at least 245° C., at least 250° C., at least 255° C., at least 260° C., at least 265° C., at least 270° C., at least 275° C., at least 280° C., at least 285° C., at least 290° C., at least 295° C., at least 300° C., or at least 305° C.;
(iii) a peak molecular weight as determined by size exclusion chromatography against a polystyrene standard of at least 200 kDa, at least 250 kDa, at least 300 kDa, at least 350 kDa, at least 400 kDa, at least 450 kDa, at least 500 kDa, at least 550 kDa, at least 600 kDa, at least 650 kDa, or at least 700 kDa;
(iv) an elongation at break of a film having a thickness of 25 micrometer (±5 micrometer) of the polyimide material as determined by ASTM D638-14 of not more than 10%, not more than 9.5%, not more than 9%, not more than 8.5%, not more than 8%, not more than 7.5%, not more than 7%, not more than 6.5%, not more than 6.2%, not more than 6.0%, not more than 5.8%, not more than 5.6%, not more than 5.4%, not more than 5.2%, not more than 5%, or not more than 4.8%; or
(v) a folding endurance of a film having a thickness of 25 micrometer (±5 micrometer) of the polyimide material as determined according to ASTM D2176-16 over a pin having a radius of 1 mm of at least 10,000 folds, at least 20,000 folds, at least 50,000 folds, at least 80,000 folds, at least 100,000 folds, at least 150,000 folds, at least 180,000 folds, at least 200,000 folds, at least 250,000 folds, at least 300,000 folds, at least 500,000 folds, or at least 1,000,000 folds.

The property group O refers predominately to optical properties and can include:
(i) an optical transparency of a film having a thickness of 25 micrometer (±5 micrometer) of the polyimide material as determined by UV-Vis spectroscopy at 400 nm of at least 20%, at least 25%, at least 30%, at least 32%, at least 34%, at least 36%, at least 38%, at least 40%, at least 42%, or at least 44%;
(ii) an optical transparency of a film having a thickness of 25 micrometer (±5 micrometer) of the polyimide material as determined by UV-Vis spectroscopy at 550 nm of at least 85%, at least 86%, at least 87%, at least 88%, at least 89%, at least 90%, at least 91%, at least 92%, at least 94%, or at least 96%;
(iii) an optical transparency of a film having a thickness of 25 micrometer (±5 micrometer) of the polyimide material as determined by UV-Vis spectroscopy at 330 nm of not greater than 50%, not greater than 48%, not greater than 46%, not greater than 44%, not greater than 42%, not greater than 40%, not greater than 38%, not greater than 36%, not greater than 34%, not greater than 32%, not greater than 30%, not greater than 28%, not greater than 26%, not greater than 24%, not greater than 22%, not greater than 20%, not greater than 18%, or not greater than 16%;
(iv) a thickness retardation Rₜₕ of not more than 100 nm, not more than 80 nm, not more than 60 nm, not more than 50 nm, not more than 40 nm, not more than 30 nm, not more than 28 nm, not more than 26 nm, not more than 24 nm, not more than 22 nm, or not more than 20 nm;
(v) a Yellow Index according to ASTM E313 of not more than 4.0, not more than 3.5, not more than 3.2, not more than 3.0, not more than 2.8, not more than 2.6, not more than 2.4, not more than 2.2, not more than 2.0, not more than 1.8, not more than 1.6, or not more than 1.4; or
(vi) a haze as determined according to ASTM D1003-13 of not greater than 1.5%, not greater than 1.3%, not greater than 1.1%, not greater than 1.0%, not greater than 0.8%, not greater than 0.6%, not greater than 0.5%, not greater than 0.4%, or not greater than 0.3%.

In a second aspect, an optical stack comprises a polyimide material according to the foregoing first aspect.

In a third aspect, an electronic device comprises a polyimide material according to the foregoing first aspect.

In a fourth aspect, a polyimide is made from a first monomer comprising Formula (II):

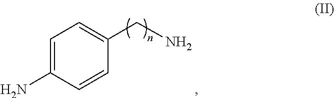

wherein n is 1, 2, or 3; and at least one second monomer. The at least one second monomer can be selected from the group consisting of:

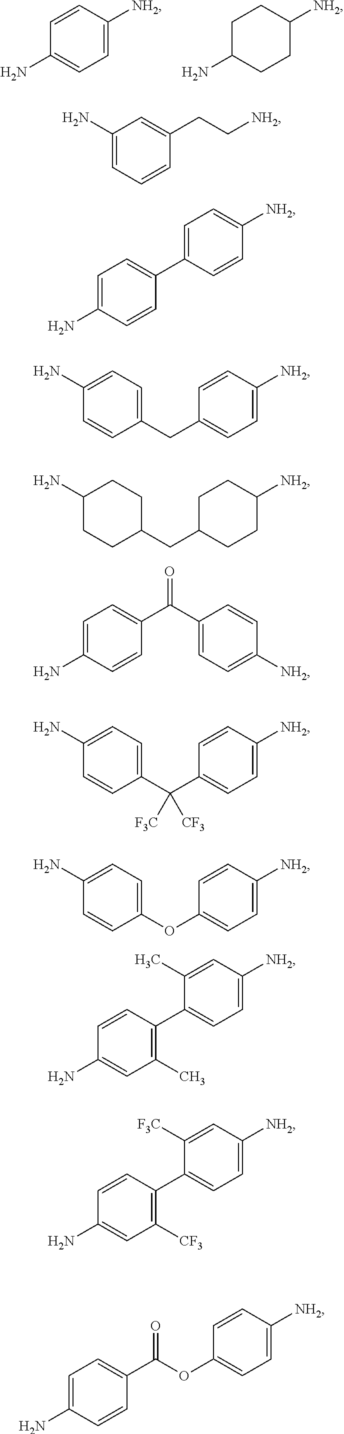

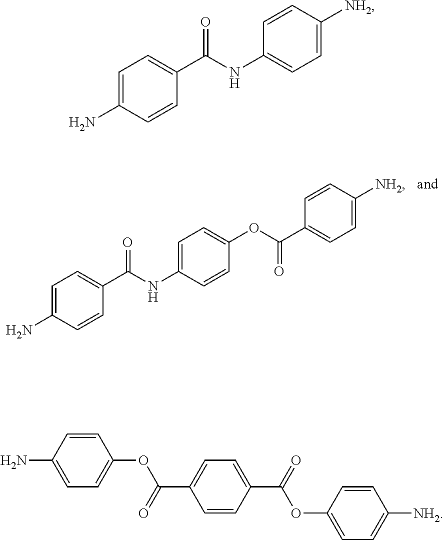 [SMILES: Nc1ccc(NC(=O)c2ccc(N)cc2)cc1 ; Nc1ccc(C(=O)Nc2ccc(OC(=O)c3ccc(N)cc3)cc2)cc1 ; "and" ; Nc1ccc(OC(=O)c2ccc(C(=O)Oc3ccc(N)cc3)cc2)cc1]

The polyimide can further include at least one co-monomer selected from the group consisting of:

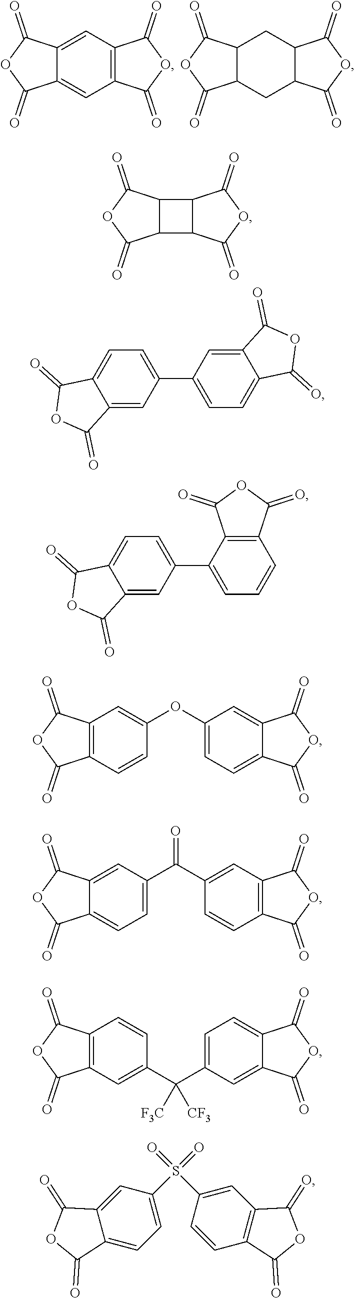

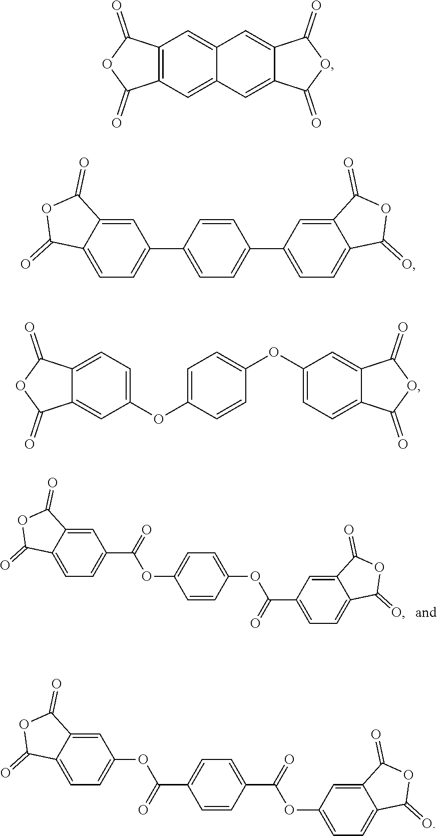

In a fifth aspect, a polyimide material comprises a polyimide of Formula (III)

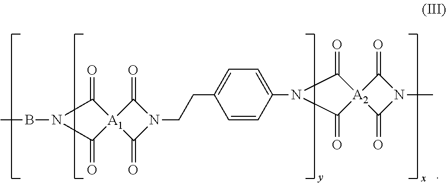

The moieties A₁ and A₂ can for each occasion be independently selected from a group of tetravalent moieties. The moiety B can for each occasion be independently selected from a group of divalent moieties. Parameters x and y are integers greater than 1.

The polyimide material according to the fifth aspect has at least one property selected from the foregoing property group M and at least one property selected from the foregoing property group O.

### DETAILED DESCRIPTION OF THE PREFERRED EMBODIMENT(S)

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings.

As used herein, the terms “comprises”, “comprising”, “includes”, “including”, “has”, “having” or any other variation thereof, are open-ended terms and should be interpreted to mean “including, but not limited to . . . .” These terms encompass the more restrictive terms “consisting essentially of” and “consisting of.” In an embodiment, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise. For example, when a single item is described herein, more than one item may be used in place of a single item. Similarly, where more than one item is described herein, a single item may be substituted for that more than one item.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in reference books and other sources within the structural arts and corresponding manufacturing arts. Unless indicated otherwise, all measurements are at about 23° C.+/−5° C. per ASTM, unless indicated otherwise.

As described above, a polyimide material comprises a polyimide of Formula (I) or Formula (III):

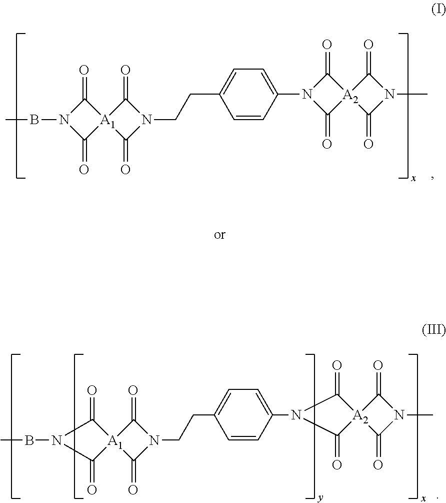

For each formula (I) or (III), the moieties A₁ and A₂ can be selected independently for each occasion. A₁ and A₂ are selected from a group of tetravalent moieties. In one embodiment, A₁ and A₂ are different. The moiety B, for each occasion independently, can be selected from a group of divalent moieties. The parameters x and y can be an integer greater than 1. In one embodiment x or y can be greater than 10, greater than 50, greater than 100, greater than 200, greater than 500, greater than 700, or greater than 1000.

In one embodiment, the polyimide material has at least one property selected from the following property group M. In another embodiment, the polyimide material has at least two, at least three, or at least four properties selected from the following property group M. The property group M refers to structural, thermal, or mechanical properties and can include:
(i) a tensile strength of the polyimide material as determined according to ASTM standard D897-08 of at least 2.5 GPa, at least 2.8 GPa, at least 3.0 GPa, at least 3.3 GPa, at least 3.5 GPa, at least 3.8 GPa, at least 4.0 GPa, at least 4.3 GPa, at least 4.5 GPa, at least 4.8 GPa, or at least 5.0 GPa;
(ii) a glass transition temperature of the polyimide material as determined by thermomechanical analysis of at least 180° C., at least 185° C., at least 190° C., at least 195° C., at least 200° C., at least 205° C., at least 210° C., at least 215° C., at least 220° C., at least 225° C., at least 230° C., at least 235° C., at least 240° C., at least 245° C., at least 250° C., at least 255° C., at least 260° C., at least 265° C., at least 270° C., at least 275° C., at least 280° C., at least 285° C., at least 290° C., at least 295° C., at least 300° C., or at least 305° C.;
(iii) a peak molecular weight as determined by size exclusion chromatography against a polystyrene standard of at least 200 kDa, at least 250 kDa, at least 300 kDa, at least 350 kDa, at least 400 kDa, at least 450 kDa, at least 500 kDa, at least 550 kDa, at least 600 kDa, at least 650 kDa, or at least 700 kDa;
(iv) an elongation at break of a film having a thickness of 25 micrometer (±5 micrometer) of the polyimide material as determined by ASTM D638-14 of not more than 10%, not more than 9.5%, not more than 9%, not more than 8.5%, not more than 8%, not more than 7.5%, not more than 7%, not more than 6.5%, not more than 6.2%, not more than 6.0%, not more than 5.8%, not more than 5.6%, not more than 5.4%, not more than 5.2%, not more than 5%, or not more than 4.8%; or
(v) a folding endurance of a film having a thickness of 25 micrometer (±5 micrometer) of the polyimide material as determined according to ASTM D2176-16 over a pin having a radius of 1 mm of at least 10,000 folds, at least 20,000 folds, at least 50,000 folds, at least 80,000 folds, at least 100,000 folds, at least 150,000 folds, at least 180,000 folds, at least 200,000 folds, at least 250,000 folds, at least 300,000 folds, at least 500,000 folds, or at least 1,000,000 folds.

The polyimide can have at least one property selected from the following property group O. In another embodiment, the polyimide material has at least two, at least three, or at least four properties selected from the following property group O. The property group O refers predominately to optical properties and can include:
(i) an optical transparency of a film having a thickness of 25 micrometer (±5 micrometer) of the polyimide material as determined by UV-Vis spectroscopy at 400 nm of at least 20%, at least 25%, at least 30%, at least 32%, at least 34%, at least 36%, at least 38%, at least 40%, at least 42%, or at least 44%;
(ii) an optical transparency of a film having a thickness of 25 micrometer (±5 micrometer) of the polyimide material as determined by UV-Vis spectroscopy at 550 nm of at least 85%, at least 86%, at least 87%, at least 88%, at least 89%, at least 90%, at least 91%, at least 92%, at least 94%, or at least 96%;
(iii) an optical transparency of a film having a thickness of 25 micrometer (±5 micrometer) of the polyimide material as determined by UV-Vis spectroscopy at 330 nm of not greater than 50%, not greater than 48%, not greater than 46%, not greater than 44%, not greater than 42%, not greater than 40%, not greater than 38%, not greater than 36%, not greater than 34%, not greater than 32%, not greater than 30%, not greater than 28%, not greater than 26%, not greater than 24%, not greater than 22%, not greater than 20%, not greater than 18%, or not greater than 16%;
(iv) a thickness retardation Rₜₕ of not more than 100 nm, not more than 80 nm, not more than 60 nm, not more than 50 nm, not more than 40 nm, not more than 30 nm, not more than 28 nm, not more than 26 nm, not more than 24 nm, not more than 22 nm, or not more than 20 nm;
(v) a Yellow Index according to ASTM E313 of a film having a thickness of 25 micrometer (±5 micrometer) of the polyimide material of not more than 4.0, not more than 3.5, not more than 3.2, not more than 3.0, not more than 2.8, not more than 2.6, not more than 2.4, not more than 2.2, not more than 2.0, not more than 1.8, not more than 1.6, or not more than 1.4; or
(vi) a haze as determined according to ASTM D1003-13 of a film having a thickness of 25 micrometer (±5 micrometer) of the polyimide material of not greater than 1.5%, not greater than 1.3%, not greater than 1.1%, not greater than 1.0%, not greater than 0.8%, not greater than 0.6%, not greater than 0.5%, not greater than 0.4%, or not greater than 0.3%.

In one embodiment, the moieties A₁ or A₂ are selected independently for each occasion from:

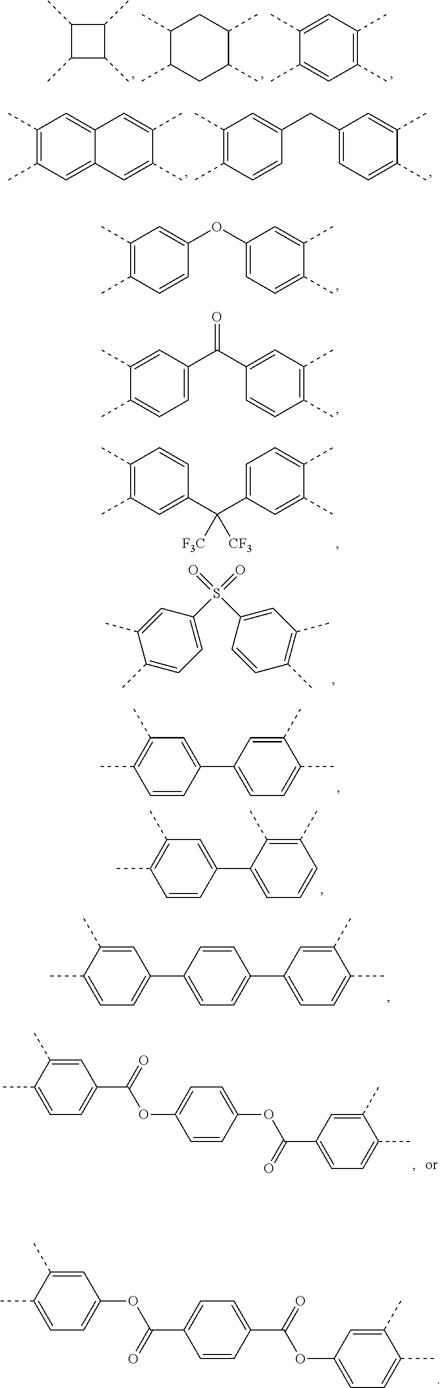

In one embodiment, A₁ and A₂ can be different.

In another embodiment, A₁ or A₂ can be selected independently for each occasion from the group consisting essentially of:

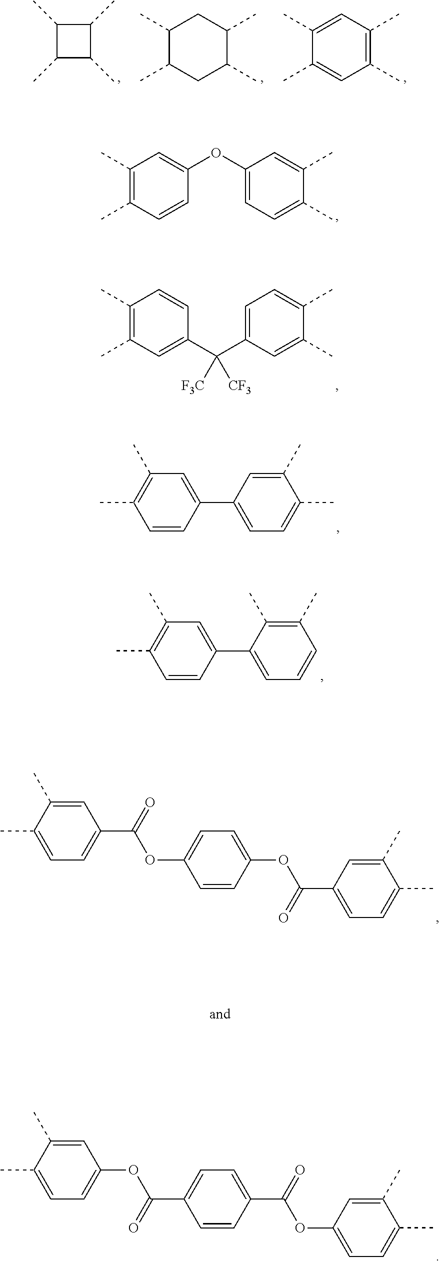

In one further embodiment, A₁ or A₂ can be selected independently for each occasion from the group consisting of:

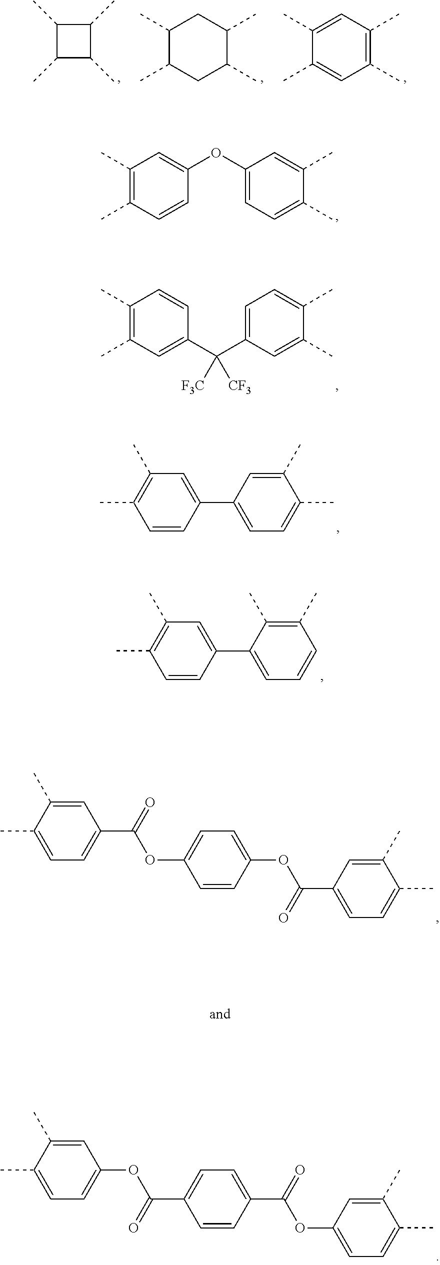

In yet another embodiment, A₁ or A₂ can be selected independently for each occasion from the group consisting of:

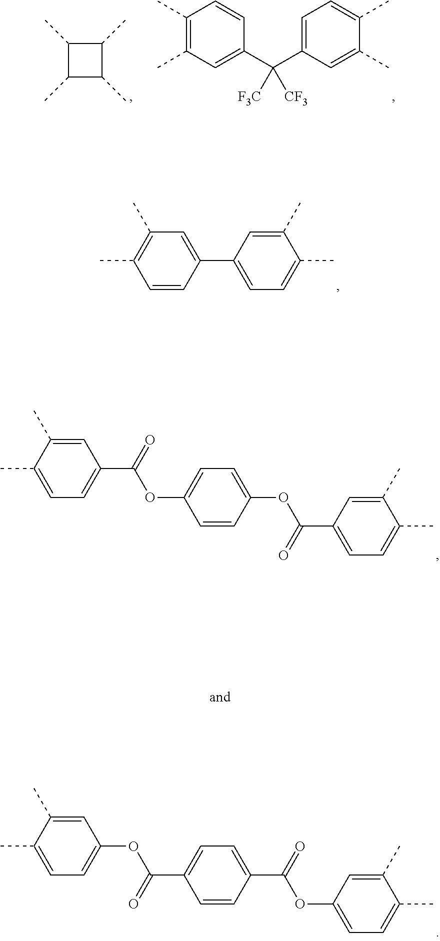

Moreover in one embodiment, A₁ is

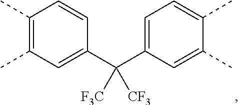

### and A₂ is

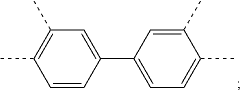

while in another embodiment A₁ is

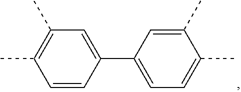

### and A₂ is

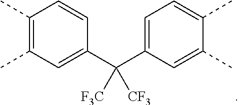

In one embodiment, the polyimide material includes polymers, wherein B can be selected independently for each occasion from:

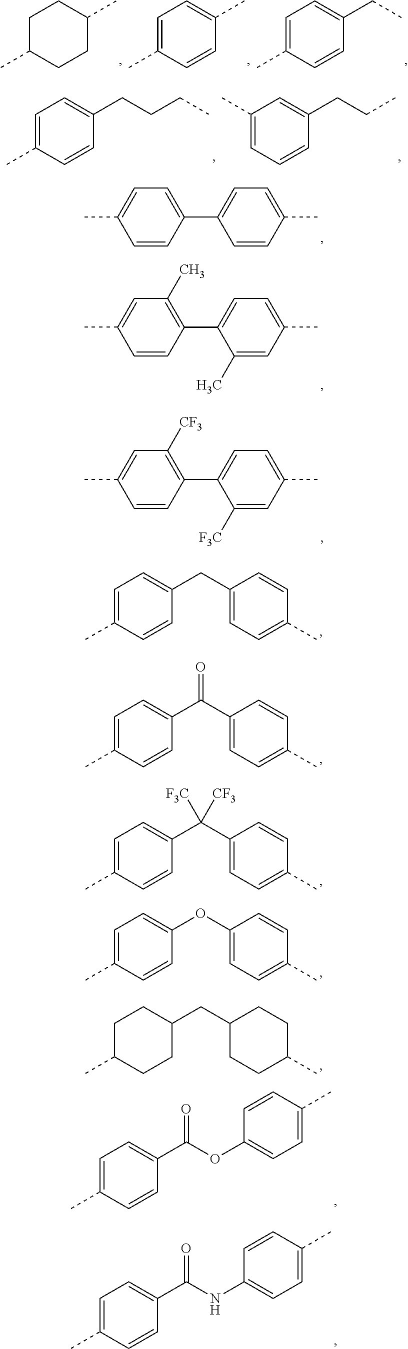

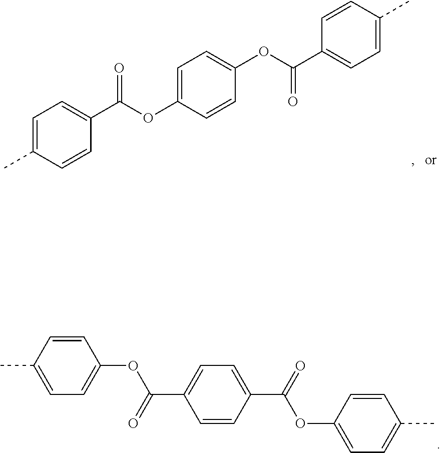

In one embodiment, B can be selected independently for each occasion from the group consisting of:

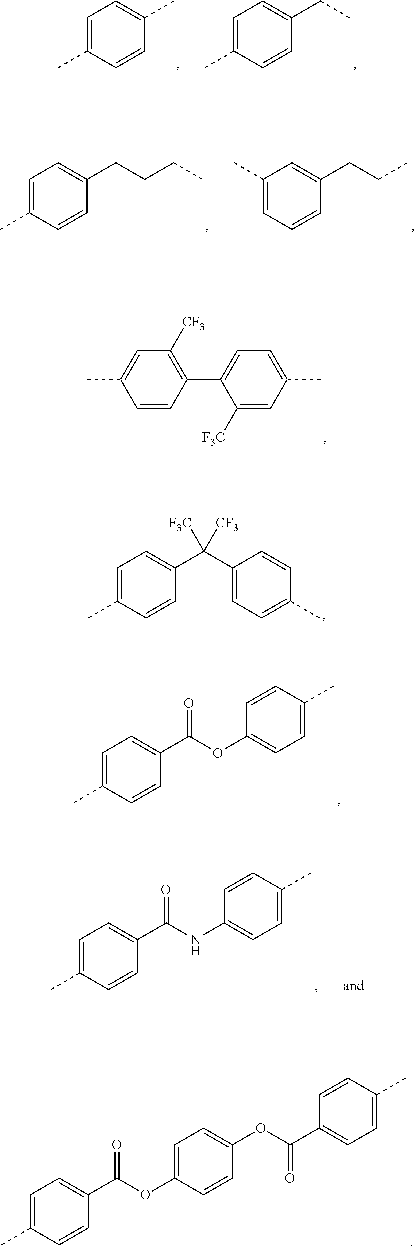

As described above, the property group M comprises:
(i) a tensile strength of the polyimide material as determined according to ASTM standard D897-08 of at least 2.5 GPa, at least 2.8 GPa, at least 3.0 GPa, at least 3.3 GPa, at least 3.5 GPa, at least 3.8 GPa, at least 4.0 GPa, at least 4.3 GPa, at least 4.5 GPa, at least 4.8 GPa, or at least 5.0 GPa;
(ii) a glass transition temperature of the polyimide material as determined by thermomechanical analysis of at least 180° C., at least 185° C., at least 190° C., at least 195° C., at least 200° C., at least 205° C., at least 210° C., at least 215° C., at least 220° C., at least 225° C., at least 230° C., at least 235° C., at least 240° C., at least 245° C., at least 250° C., at least 255° C., at least 260° C., at least 265° C., at least 270° C., at least 275° C., at least 280° C., at least 285° C., at least 290° C., at least 295° C., at least 300° C., or at least 305° C.;
(iii) a peak molecular weight as determined by size exclusion chromatography against a polystyrene standard of at least 200 kDa, at least 250 kDa, at least 300 kDa, at least 350 kDa, at least 400 kDa, at least 450 kDa, at least 500 kDa, at least 550 kDa, at least 600 kDa, at least 650 kDa, or at least 700 kDa;
(iv) an elongation at break of a film having a thickness of 25 micrometer (±5 micrometer) of the polyimide material as determined by ASTM D638-14 of not more than 10%, not more than 9.5%, not more than 9%, not more than 8.5%, not more than 8%, not more than 7.5%, not more than 7%, not more than 6.5%, not more than 6.2%, not more than 6.0%, not more than 5.8%, not more than 5.6%, not more than 5.4%, not more than 5.2%, not more than 5%, or not more than 4.8%; or
(v) a folding endurance of a film having a thickness of 25 micrometer (±5 micrometer) of the polyimide material as determined according to ASTM D2176-16 over a pin having a radius of 1 mm of at least 10,000 folds, at least 20,000 folds, at least 50,000 folds, at least 80,000 folds, at least 100,000 folds, at least 150,000 folds, at least 180,000 folds, at least 200,000 folds, at least 250,000 folds, at least 300,000 folds, at least 500,000 folds, or at least 1,000,000 folds.

In one embodiment, the polyimide material according to any one of the embodiments discussed herein can have at least two, at least three, or at least four properties of property group M.

As discussed above, the property group O can include:
(i) an optical transparency of a film having a thickness of 25 micrometer (±5 micrometer) of the polyimide material as determined by UV-Vis spectroscopy at 400 nm of at least 20%, at least 25%, at least 30%, at least 32%, at least 34%, at least 36%, at least 38%, at least 40%, at least 42%, or at least 44%;
(ii) an optical transparency of a film having a thickness of 25 micrometer (±5 micrometer) of the polyimide material as determined by UV-Vis spectroscopy at 550 nm of at least 85%, at least 86%, at least 87%, at least 88%, at least 89%, at least 90%, at least 91%, at least 92%, at least 94%, or at least 96%;
(iii) an optical transparency of a film having a thickness of 25 micrometer (±5 micrometer) of the polyimide material as determined by UV-Vis spectroscopy at 330 nm of not greater than 50%, not greater than 48%, not greater than 46%, not greater than 44%, not greater than 42%, not greater than 40%, not greater than 38%, not greater than 36%, not greater than 34%, not greater than 32%, not greater than 30%, not greater than 28%, not greater than 26%, not greater than 24%, not greater than 22%, not greater than 20%, not greater than 18%, or not greater than 16%;
(iv) a thickness retardation Rₜₕ of not more than 100 nm, not more than 80 nm, not more than 60 nm, not more than 50 nm, not more than 40 nm, not more than 30 nm, not more than 28 nm, not more than 26 nm, not more than 24 nm, not more than 22 nm, or not more than 20 nm;
(v) a Yellow Index according to ASTM E313 of a film having a thickness of 25 micrometer (±5 micrometer) of the polyimide material of not more than 4.0, not more than 3.5, not more than 3.2, not more than 3.0, not more than 2.8, not more than 2.6, not more than 2.4, not more than 2.2, not more than 2.0, not more than 1.8, not more than 1.6, or not more than 1.4; or
(vi) a haze as determined according to ASTM D1003-13 of a film having a thickness of 25 micrometer (±5 micrometer) of the polyimide material of not greater than 1.5%, not greater than 1.3%, not greater than 1.1%, not greater than 1.0%, not greater than 0.8%, not greater than 0.6%, not greater than 0.5%, not greater than 0.4%, or not greater than 0.3%.

In one embodiment, the polyimide material according to any one of the embodiments recited herein can have at least two, at least three, or at least four properties of property group O.

As described above, one aspect of the present disclosure includes a polyimide that is made from a first monomer comprising Formula (II):

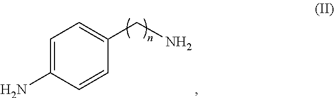

wherein n is 1, 2, or 3; and at least one second monomer.

In one embodiment, the first monomer can be selected from:

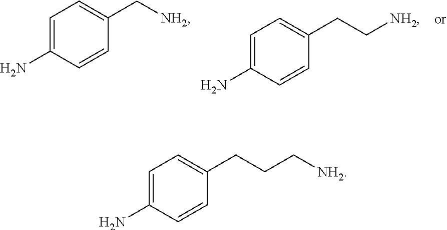 [SMILES: NCc1ccc(N)cc1 ; NCCc1ccc(N)cc1 ; "or" ; NCCCc1ccc(N)cc1]

In another embodiment, the first monomer can be selected from 4-aminophenylmethylamine (4-APMA) or 4-aminophenylethylamine (4-APEA). In one further embodiment, the first monomer consists essentially of 4-APEA.

The polyimide is made from at least one second monomer. The at least one second monomer selected from:

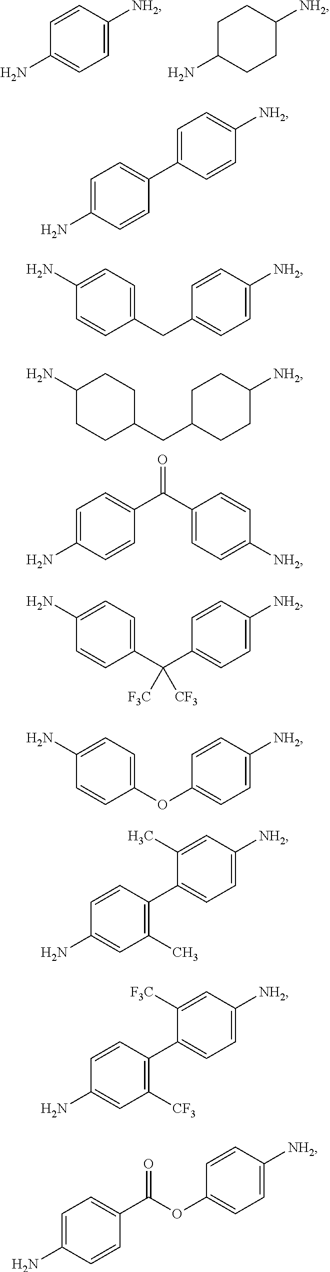

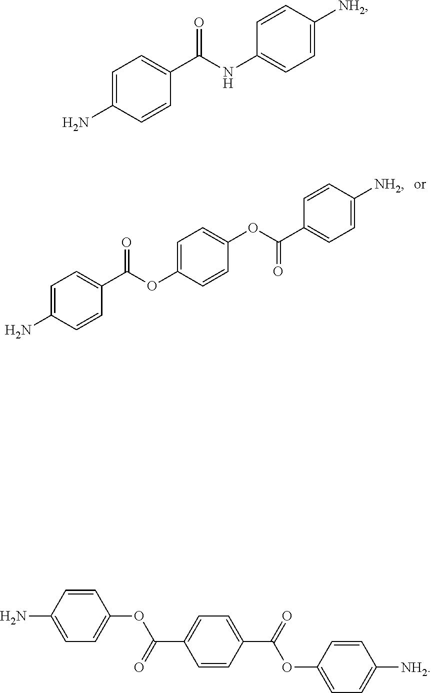 [SMILES: Nc1ccc(NC(=O)c2ccc(N)cc2)cc1 ; Nc1ccc(C(=O)Oc2ccc(OC(=O)c3ccc(N)cc3)cc2)cc1 ; Nc1ccc(OC(=O)c2ccc(C(=O)Oc3ccc(N)cc3)cc2)cc1]

In one embodiment, the at least one second monomer is selected from:

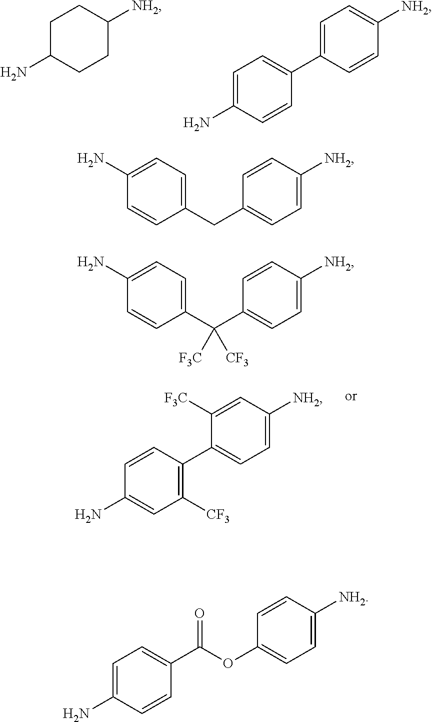

In one embodiment the at least one second monomer consists essentially of 4,4′-Diamino-2,2′-bis(trifluoromethyl)biphenyl (TFMB).

According to the foregoing aspect, the polyimide is made from at least one co-monomer selected from:

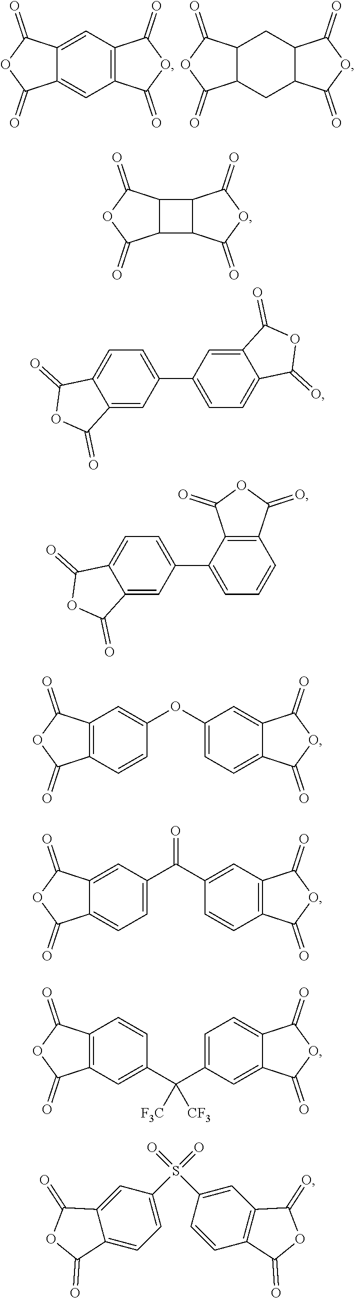

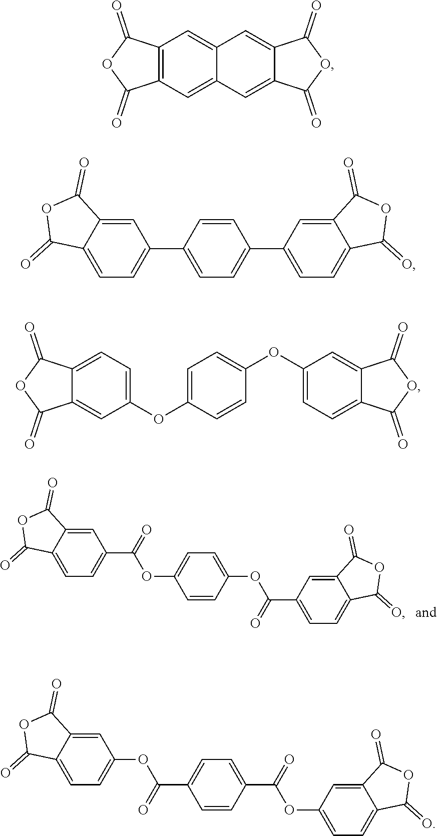

In one embodiment, the at least one co-monomer is selected from:

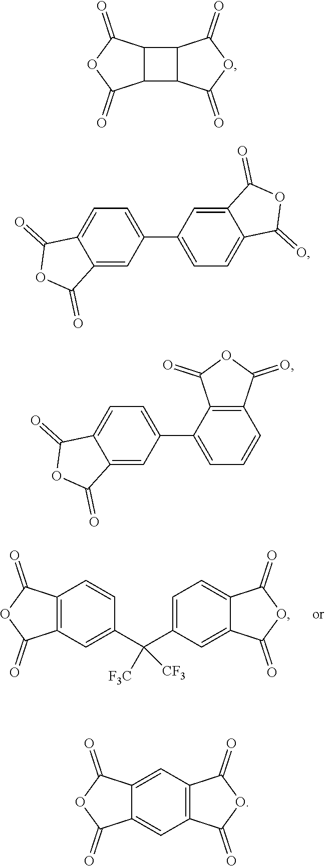

In one embodiment, the at least one co-monomers includes two, three, or four co-monomers. For example, two co-monomers can be selected from

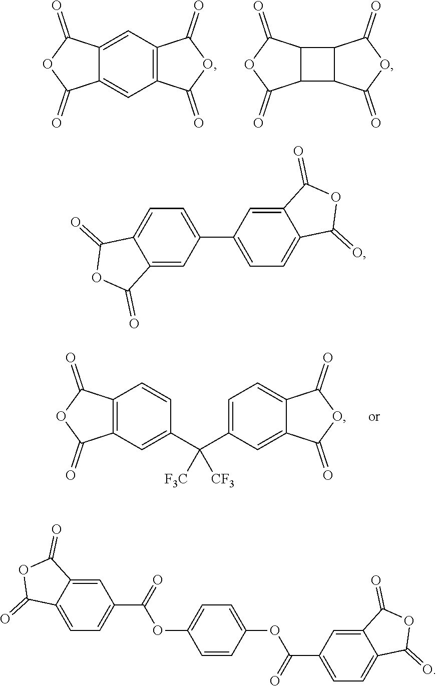

In one embodiment, two co-monomers are 4,4′-(Hexafluoroisopropylidene)diphthalic anhydride (6FDA) and 3,3′,4,4′-Biphenyltetracarboxylic dianhydride (s-BPDA).

In one embodiment, derivatives of the first and second monomer are within the scope of this disclosure. For example, any salt of the foregoing diamines are considered. Moreover, any reactive derivatives of the co-monomer is considered within the scope of the present disclosure. For example any ester of the dianhydrides, such as mono-, di-, tri-, and tetraesters are considered. For example, the tetrakis-pentafluoroehtyl esters of 6FDA as shown below is considered:

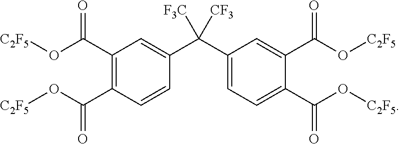

In one embodiment, the first and the second monomer can be in any molar ratio. The molar ratio of the first:second monomer can range from 10:1 to 1:10, from 5:1 to 1:5, from 3:1 to 1:3, from 2:1 to 1:2, from 3:2 to 2:3, from 4:3 to 3:4, from 5:4 to 4:5, from 6:5 to 5:6, from 7:6 to 6:7, from 8:7 to 7:8, from 9:8 to 8:9, or from 10:9 to 9:10. In one embodiment, the first monomer is in the majority. In another embodiment, the polyimide may include a third, a fourth, and further monomers. For such multiple monomeric systems, the molar ratio of first to the sum of all other monomers can range from 10:1 to 1:10, from 5:1 to 1:5, from 3:1 to 1:3, from 2:1 to 1:2, from 3:2 to 2:3, from 4:3 to 3:4, from 5:4 to 4:5, from 6:5 to 5:6, from 7:6 to 6:7, from 8:7 to 7:8, from 9:8 to 8:9, or from 10:9 to 9:10.

In yet another embodiment, the polyimide according to the foregoing aspect can be made from two co-monomers, a first and a second co-monomer. The first co-monomers to the second can be in a molar ratio ranging from 10:1 to 1:10, from 5:1 to 1:5, from 3:1 to 1:3, from 2:1 to 1:2, from 3:2 to 2:3, from 4:3 to 3:4, from 5:4 to 4:5, from 6:5 to 5:6, from 7:6 to 6:7, from 8:7 to 7:8, from 9:8 to 8:9, or from 10:9 to 9:10.

In another embodiment, the polyimide according to the foregoing aspect can be made from three or more co-monomers. In one embodiment, the first co-monomer is 6FDA and the second and other co-monomer can be selected from the aforementioned structures. The molar ratio of the first co-monomer to the sum of all the remaining co-monomers can range from 10:1 to 1:10, from 5:1 to 1:5, from 3:1 to 1:3, from 2:1 to 1:2, from 3:2 to 2:3, from 4:3 to 3:4, from 5:4 to 4:5, from 6:5 to 5:6, from 7:6 to 6:7, from 8:7 to 7:8, from 9:8 to 8:9, or from 10:9 to 9:10.

In one particular embodiment, the polyimide according to the foregoing aspect can be made from compounds, wherein the first monomer is 4APEA, the second monomer is TFMB, a first co-monomer is 6FDA, and a second co-monomer is s-BPDA. In one embodiment, the first and second monomers are in a molar ratio ranging from 6:5 to 5:6 and the first co-monomer to the second co-monomer is in a molar ratio of 2:1 to 1:1. In one embodiment, the molar ratio of 4APEA:TFMB:6FDA:s-BPDA is about 5:5:6:4.

According to the aforementioned aspects, a polyimide material includes a polyimide of Formula III:

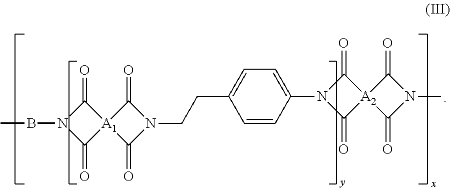

Polyimide according to Formula III can be made by a controlled polymerisation step when 4APEA is first redacted with a compound comprising the A₁ moiety followed by the addition of the diamine comprising the B moiety and the compound comprising the A₂ moiety. In the foregoing formula II, A₁ and A₂ for each occasion independently can be selected from a group of tetravalent moieties. Moiety B for each occasion independently can be selected from a group of divalent moieties. Parameters x and y are integers greater than 1.

In one embodiment, x and y are in a ratio ranging from 10:1 to 1:10, from 5:1 to 1:5, from 3:1 to 1:3, from 2:1 to 1:2, from 3:2 to 2:3, from 4:3 to 3:4, from 5:4 to 4:5, from 6:5 to 5:6, from 7:6 to 6:7, from 8:7 to 7:8, from 9:8 to 8:9, or from 10:9 to 9:10.

In an embodiment, the polyimide material has at least one property selected from the following property group M and at least one property selected from the following property group O. The property group M comprises:
(i) a tensile strength as determined according to ASTM standard D897-08 of at least 2.5 GPa, at least 2.8 GPa, at least 3.0 GPa, at least 3.3 GPa, at least 3.5 GPa, at least 3.8 GPa, at least 4.0 GPa, at least 4.3 GPa, at least 4.5 GPa, at least 4.8 GPa, or at least 5.0 GPa;
(ii) a glass transition temperature as determined by thermomechanical analysis of at least 180° C., at least 185° C., at least 190° C., at least 195° C., at least 200° C., at least 205° C., at least 210° C., at least 215° C., at least 220° C., at least 225° C., at least 230° C., at least 235° C., at least 240° C., at least 245° C., at least 250° C., at least 255° C., at least 260° C., at least 265° C., at least 270° C., at least 275° C., at least 280° C., at least 285° C., at least 290° C., at least 295° C., at least 300° C., or at least 305° C.;
(iii) a peak molecular weight as determined by size exclusion chromatography against a polystyrene standard of at least 200 kDa, at least 250 kDa, at least 300 kDa, at least 350 kDa, at least 400 kDa, at least 450 kDa, at least 500 kDa, at least 550 kDa, at least 600 kDa, at least 650 kDa, or at least 700 kDa;
(iv) an elongation at break of a film having a thickness of 25 micrometer (±5 micrometer) of the polyimide material as determined by ASTM D638-14 of not more than 10%, not more than 9.5%, not more than 9%, not more than 8.5%, not more than 8%, not more than 7.5%, not more than 7%, not more than 6.5%, not more than 6.2%, not more than 6.0%, not more than 5.8%, not more than 5.6%, not more than 5.4%, not more than 5.2%, not more than 5%, or not more than 4.8%; or
(v) a folding endurance of a film having a thickness of 25 micrometer (±5 micrometer) of the polyimide material as determined according to ASTM D2176-16 at a radius of 1 mm of at least 10,000 folds, at least 20,000 folds, at least 50,000 folds, at least 80,000 folds, at least 100,000 folds, at least 150,000 folds, at least 180,000 folds, at least 200,000 folds, at least 250,000 folds, at least 300,000 folds, at least 500,000 folds, or at least 1,000,000 folds.

The property group O comprises:
(i) an optical transparency of a film having a thickness of 25 micrometer (±5 micrometer) of the polyimide material as determined by UV-Vis spectroscopy at 400 nm of at least 20%, at least 25%, at least 30%, at least 32%, at least 34%, at least 36%, at least 38%, at least 40%, at least 42%, or at least 44%;
(ii) an optical transparency of a film having a thickness of 25 micrometer (±5 micrometer) of the polyimide material as determined by UV-Vis spectroscopy at 550 nm of at least 85%, at least 86%, at least 87%, at least 88%, at least 89%, at least 90%, at least 91%, at least 92%, at least 94%, or at least 96%;
(iii) an optical transparency of a film having a thickness of 25 micrometer (±5 micrometer) of the polyimide material of the polyimide material as determined by UV-Vis spectroscopy at 380 nm of not greater than 50%, not greater than 48%, not greater than 46%, not greater than 44%, not greater than 42%, not greater than 40%, not greater than 38%, not greater than 36%, not greater than 34%, not greater than 32%, not greater than 30%, not greater than 28%, not greater than 26%, not greater than 24%, not greater than 22%, not greater than 20%, not greater than 18%, or not greater than 16%;
(iv) a thickness retardation Rₜₕ of a film having a thickness of 25 micrometer (±5 micrometer) of the polyimide material of not more than 100 nm, not more than 80 nm, not more than 60 nm, not more than 50 nm, not more than 40 nm, not more than 30 nm, not more than 28 nm, not more than 26 nm, not more than 24 nm, not more than 22 nm, or not more than 20 nm;
(v) a Yellow Index of a film having a thickness of 25 micrometer (±5 micrometer) of the polyimide material according to ASTM E313 of not more than 4.0, not more than 3.5, not more than 3.2, not more than 3.0, not more than 2.8, not more than 2.6, not more than 2.4, not more than 2.2, not more than 2.0, not more than 1.8, not more than 1.6, or not more than 1.4; or
(vi) a haze of a film having a thickness of 25 micrometer (±5 micrometer) of the polyimide material as determined according to ASTM D1003-13 of not greater than 1.5%, not greater than 1.3%, not greater than 1.1%, not greater than 1.0%, not greater than 0.8%, not greater than 0.6%, not greater than 0.5%, not greater than 0.4%, or not greater than 0.3%.

In one embodiment, the polyimide material has at least two, at least three, or at least four properties of the property group M. In another embodiment, the polyimide material has at least two, at least three, or at least four properties of the property group O. For example, in one embodiment, the polyimide material has at least two properties from property group M and at least two properties from property group O. Accordingly, any combination of the number of properties of each property group is considered within the scope of the disclosure.

In addressing the moieties of formula III, A₁ or A₂ can be selected independently for each occasion from:

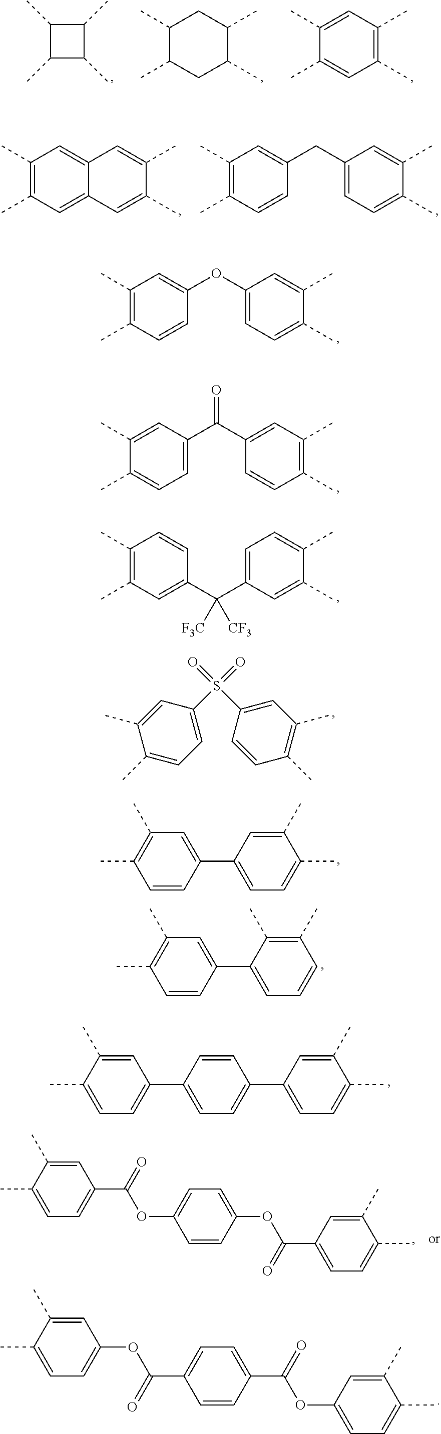

The moiety B can be selected independently for each occasion from:

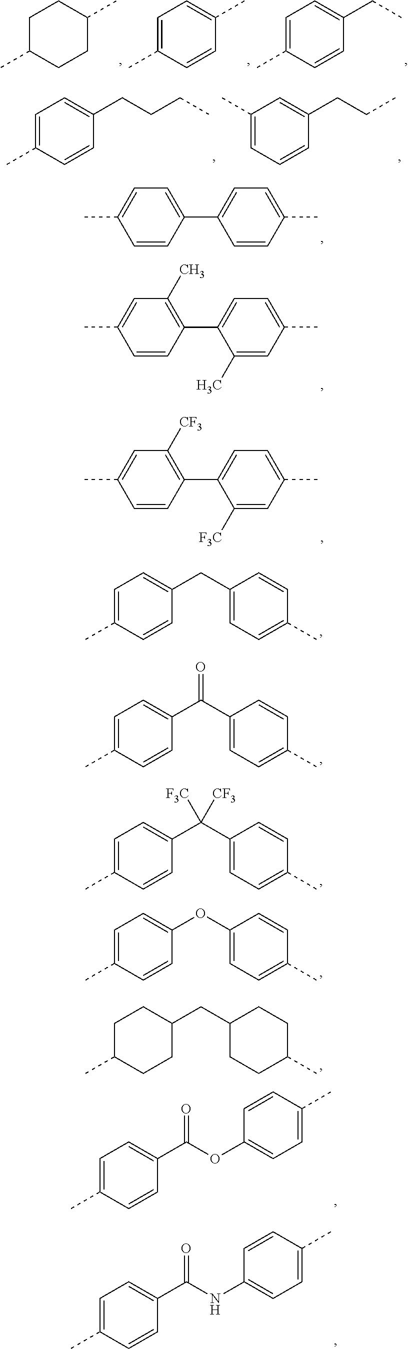

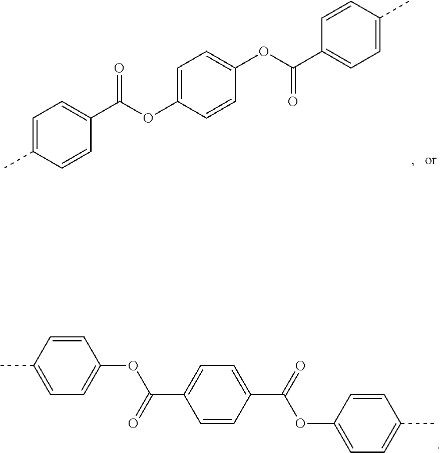

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the items as listed below.

Embodiment 1. A polyimide material including a polyimide of Formula (I)

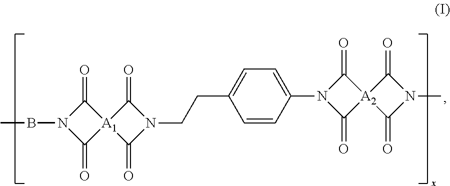

wherein A₁ and A₂ for each occasion independently are selected from a group of tetravalent moieties and B for each occasion independently is selected from a group of divalent moieties, wherein x is an integer greater than 1; wherein the polyimide material has at least one property selected from the following property group M and at least one property selected from the following property group O, wherein property group M includes:
a tensile strength of the polyimide material as determined according to ASTM standard D897-08 of at least 2.5 GPa, at least 2.8 GPa, at least 3.0 GPa, at least 3.3 GPa, at least 3.5 GPa, at least 3.8 GPa, at least 4.0 GPa, at least 4.3 GPa, at least 4.5 GPa, at least 4.8 GPa, or at least 5.0 GPa;
a glass transition temperature of the polyimide material as determined by thermomechanical analysis of at least 180° C., at least 185° C., at least 190° C., at least 195° C., at least 200° C., at least 205° C., at least 210° C., at least 215° C., at least 220° C., at least 225° C., at least 230° C., at least 235° C., at least 240° C., at least 245° C., at least 250° C., at least 255° C., at least 260° C., at least 265° C., at least 270° C., at least 275° C., at least 280° C., at least 285° C., at least 290° C., at least 295° C., at least 300° C., or at least 305° C.;
a peak molecular weight as determined by size exclusion chromatography against a polystyrene standard of at least 200 kDa, at least 250 kDa, at least 300 kDa, at least 350 kDa, at least 400 kDa, at least 450 kDa, at least 500 kDa, at least 550 kDa, at least 600 kDa, at least 650 kDa, or at least 700 kDa;
an elongation at break of a film having a thickness of 25 micrometer (±5 micrometer) of the polyimide material as determined by ASTM D638-14 of not more than 10%, not more than 9.5%, not more than 9%, not more than 8.5%, not more than 8%, not more than 7.5%, not more than 7%, not more than 6.5%, not more than 6.2%, not more than 6.0%, not more than 5.8%, not more than 5.6%, not more than 5.4%, not more than 5.2%, not more than 5%, or not more than 4.8%; or
a folding endurance of a film having a thickness of 25 micrometer (±5 micrometer) of the polyimide material as determined according to ASTM D2176-16 over a pin having a radius of 1 mm of at least 10,000 folds, at least 20,000 folds, at least 50,000 folds, at least 80,000 folds, at least 100,000 folds, at least 150,000 folds, at least 180,000 folds, at least 200,000 folds, at least 250,000 folds, at least 300,000 folds, at least 500,000 folds, or at least 1,000,000 folds; and property group O includes:
an optical transparency of a film having a thickness of 25 micrometer (±5 micrometer) of the polyimide material as determined by UV-Vis spectroscopy at 400 nm of at least 20%, at least 25%, at least 30%, at least 32%, at least 34%, at least 36%, at least 38%, at least 40%, at least 42%, or at least 44%;
an optical transparency of a film having a thickness of 25 micrometer (±5 micrometer) of the polyimide material as determined by UV-Vis spectroscopy at 550 nm of at least 85%, at least 86%, at least 87%, at least 88%, at least 89%, at least 90%, at least 91%, at least 92%, at least 94%, or at least 96%;
an optical transparency of a film having a thickness of 25 micrometer (±5 micrometer) of the polyimide material as determined by UV-Vis spectroscopy at 330 nm of not greater than 50%, not greater than 48%, not greater than 46%, not greater than 44%, not greater than 42%, not greater than 40%, not greater than 38%, not greater than 36%, not greater than 34%, not greater than 32%, not greater than 30%, not greater than 28%, not greater than 26%, not greater than 24%, not greater than 22%, not greater than 20%, not greater than 18%, or not greater than 16%;
a thickness retardation Rₜₕ of not more than 100 nm, not more than 80 nm, not more than 60 nm, not more than 50 nm, not more than 40 nm, not more than 30 nm, not more than 28 nm, not more than 26 nm, not more than 24 nm, not more than 22 nm, or not more than 20 nm;
a Yellow Index according to ASTM E313 of a film having a thickness of 25 micrometer (±5 micrometer) of the polyimide material of not more than 4.0, not more than 3.5, not more than 3.2, not more than 3.0, not more than 2.8, not more than 2.6, not more than 2.4, not more than 2.2, not more than 2.0, not more than 1.8, not more than 1.6, or not more than 1.4; or
a haze as determined according to ASTM D1003-13 of a film having a thickness of 25 micrometer (±5 micrometer) of the polyimide material of not greater than 1.5%, not greater than 1.3%, not greater than 1.1%, not greater than 1.0%, not greater than 0.8%, not greater than 0.6%, not greater than 0.5%, not greater than 0.4%, or not greater than 0.3%.

Embodiment 2. The polyimide material according to embodiment 1, wherein A₁ or A₂ are selected independently for each occasion from:

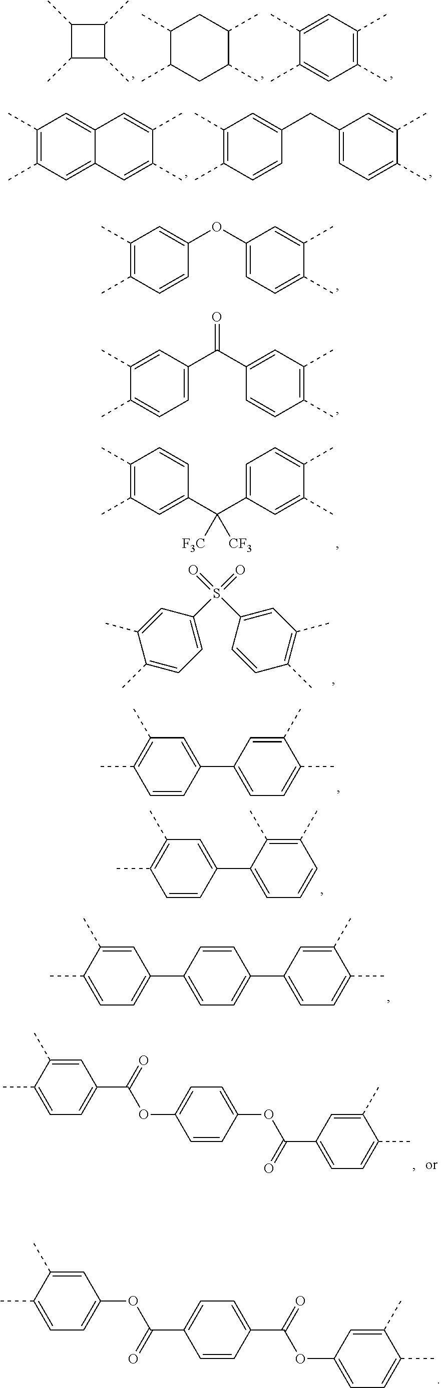

Embodiment 3. The polyimide material according to any one of the preceding embodiments, wherein A₁ or A₂ are selected independently for each occasion from the group consisting essentially of:

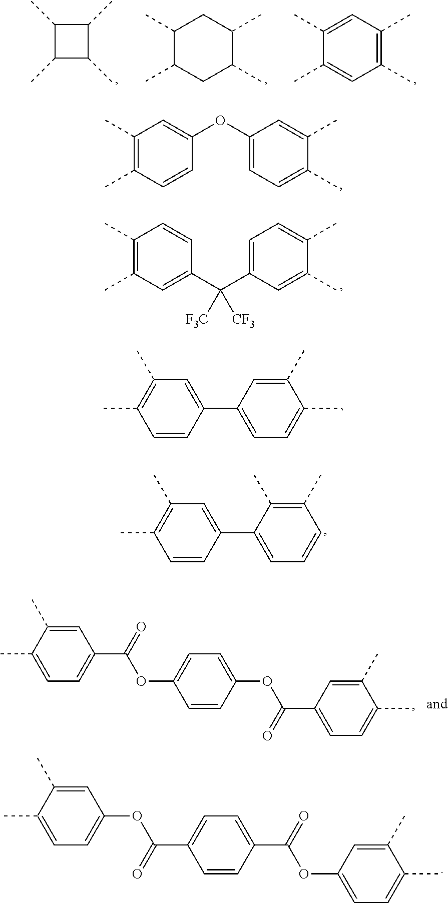

Embodiment 4. The polyimide material according to any one of the preceding embodiments, wherein A₁ or A₂ are selected independently for each occasion from the group consisting of:

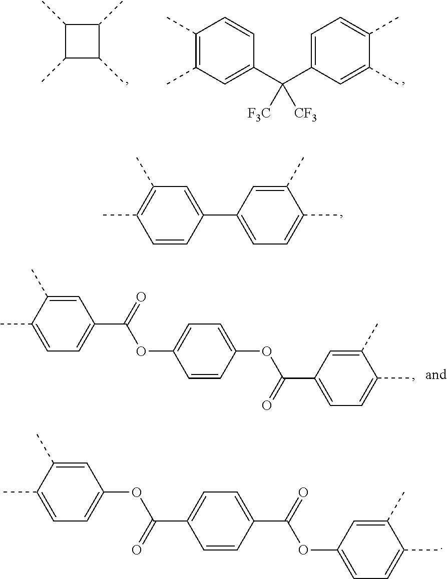

Embodiment 5. The polyimide material according to any one of the preceding embodiments, wherein B is selected independently for each occasion from:

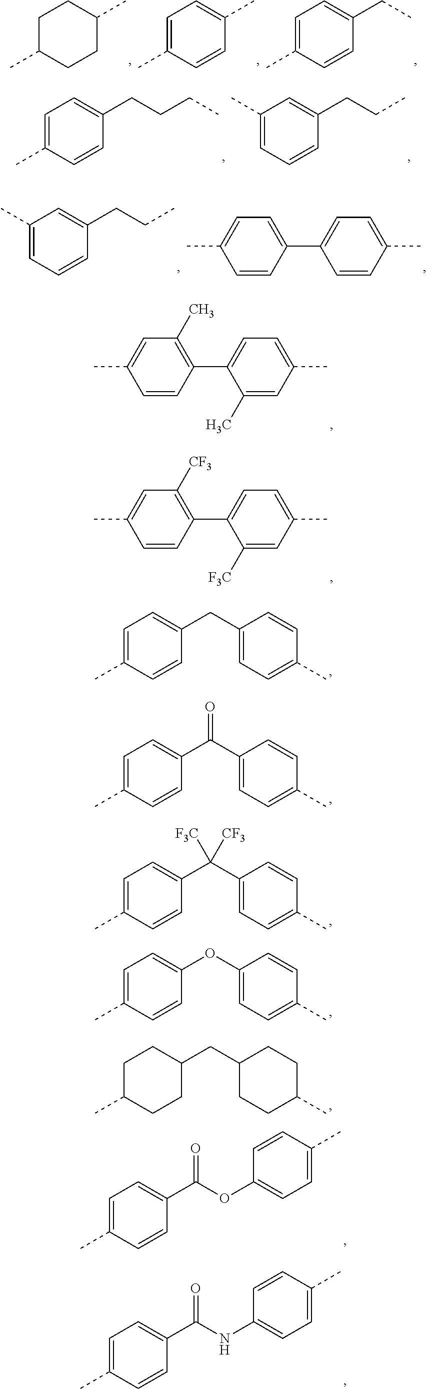

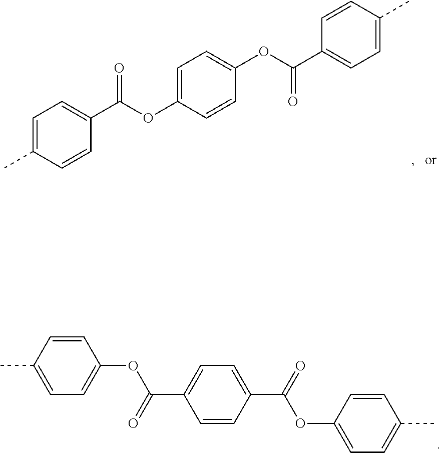

Embodiment 6. The polyimide material according to any one of the preceding embodiments, wherein B is selected independently for each occasion from the group consisting of:

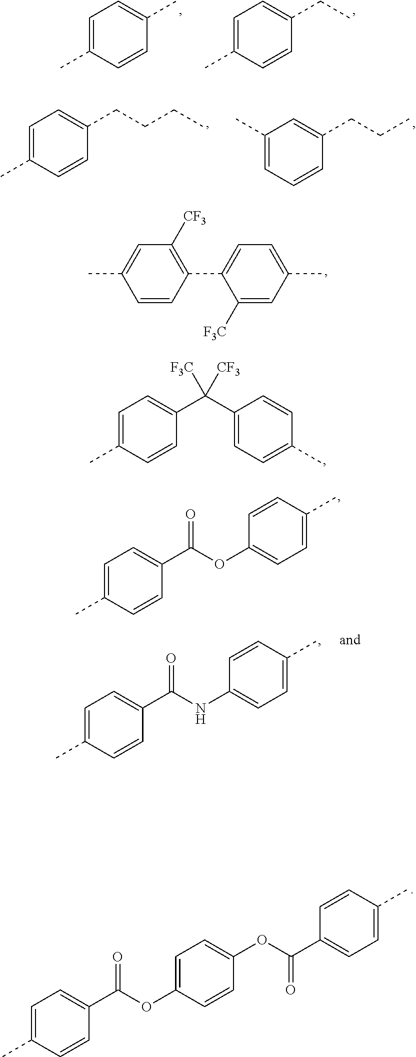

Embodiment 7. The polyimide material according to any one of the preceding embodiments having at least two, at least three, or at least four properties of property group M.

Embodiment 8. The polyimide material according to any one of the preceding embodiments having at least two, at least three, or at least four properties of property group O.

Embodiment 9. An optical stack including a polyimide material according to embodiments 1 through 8.

Embodiment 10. An electronic device including a polyimide material according to embodiments 1 through 8.

Embodiment 11. A polyimide made from a first monomer including Formula (II):

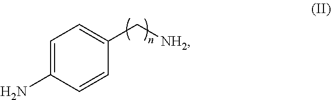

wherein n is 1, 2, or 3; and at least one second monomer selected from the group consisting of

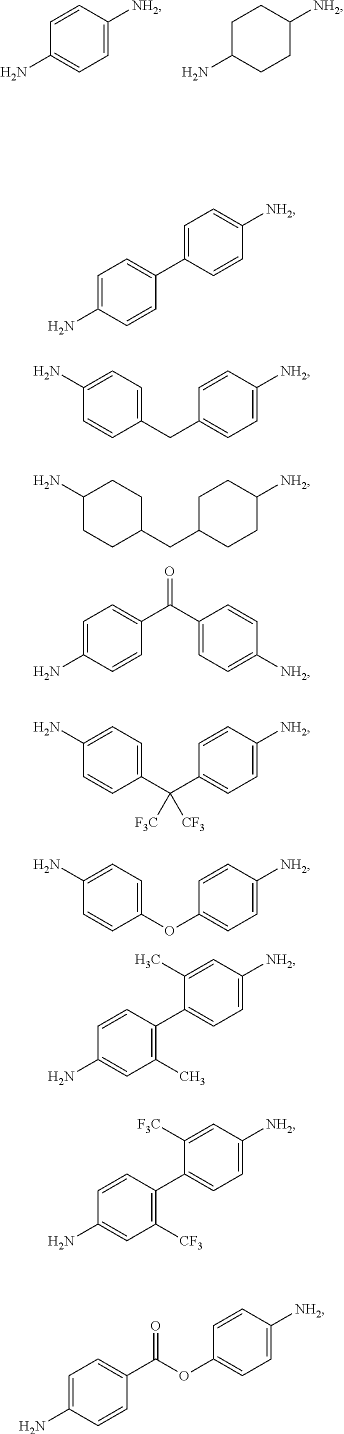

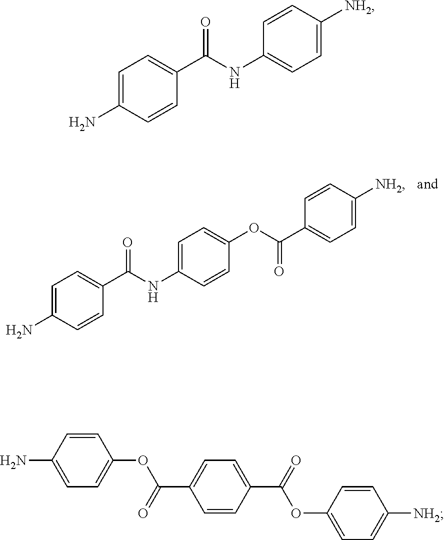 [SMILES: Nc1ccc(NC(=O)c2ccc(N)cc2)cc1 ; Nc1ccc(C(=O)Nc2ccc(OC(=O)c3ccc(N)cc3)cc2)cc1 ; "and" ; Nc1ccc(OC(=O)c2ccc(C(=O)Oc3ccc(N)cc3)cc2)cc1]

at least one co-monomer selected from the group consisting of:

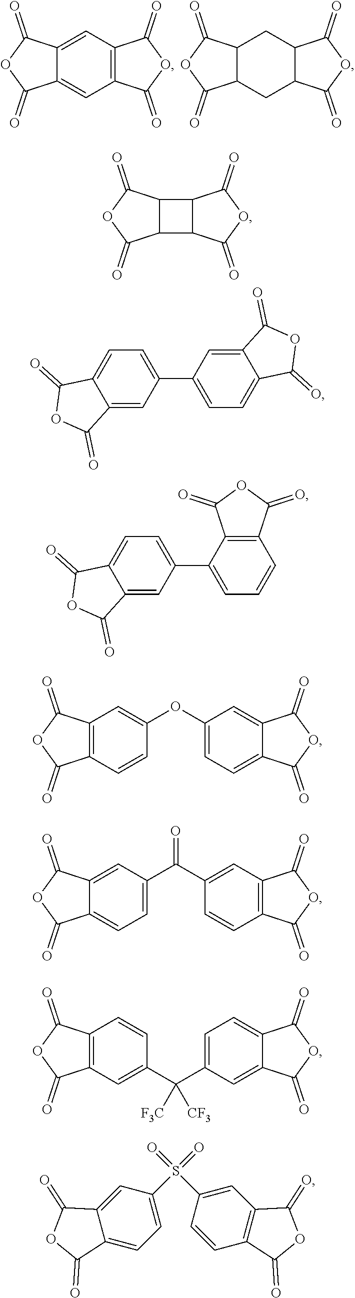

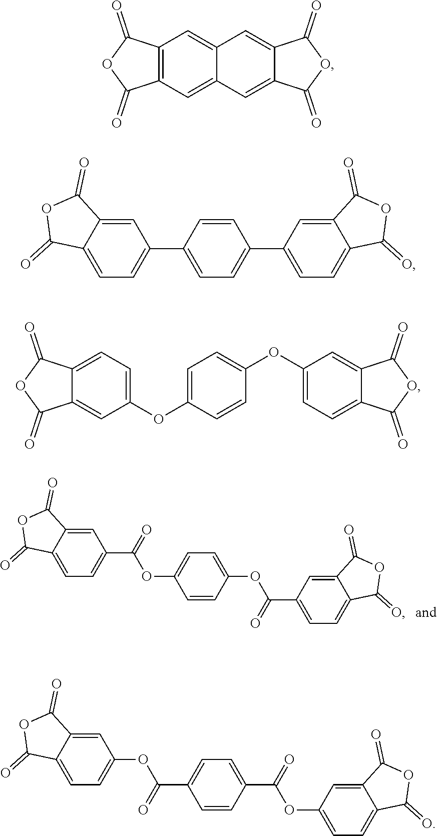

Embodiment 12. The polyimide according to embodiment 11, wherein the first and the second monomer are in a molar ratio ranging from 10:1 to 1:10, from 5:1 to 1:5, from 3:1 to 1:3, from 2:1 to 1:2, from 3:2 to 2:3, from 4:3 to 3:4, from 5:4 to 4:5, from 6:5 to 5:6, from 7:6 to 6:7, from 8:7 to 7:8, from 9:8 to 8:9, or from 10:9 to 9:10.

Embodiment 13. The polyimide according to any one of embodiments 11 and 12, made from at least two co-monomers.

Embodiment 14. The polyimide according to any one of embodiments 11 to 13, wherein the first monomer is

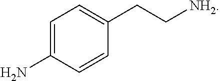

Embodiment 15. The polyimide according to any one of embodiments 11 to 14, including at least two co-monomers, wherein the two co-monomers are selected from

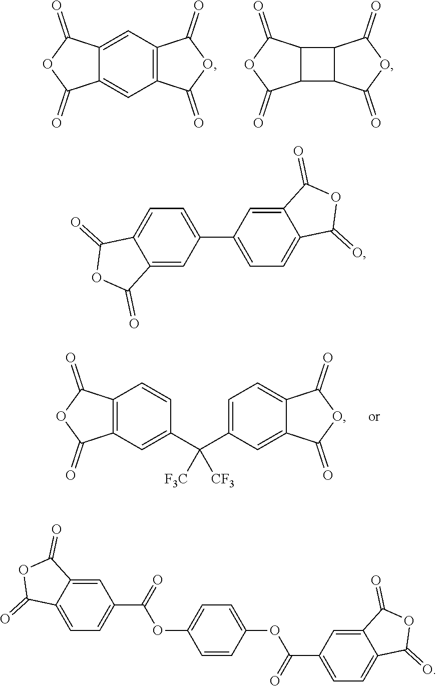

Embodiment 16. The polyimide according to embodiment 15, wherein the two co-monomers are in a molar ratio ranging from 10:1 to 1:10, from 5:1 to 1:5, from 3:1 to 1:3, from 2:1 to 1:2, from 3:2 to 2:3, from 4:3 to 3:4, from 5:4 to 4:5, from 6:5 to 5:6, from 7:6 to 6:7, from 8:7 to 7:8, from 9:8 to 8:9, or from 10:9 to 9:10.

Embodiment 17. The polyimide according to any one of embodiments 11 to 16, wherein the first monomer is

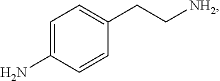

the second monomer is

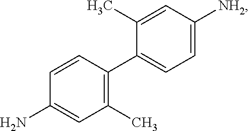 [SMILES: Cc1cc(N)ccc1-c1ccc(N)cc1C]

a first co-monomer is

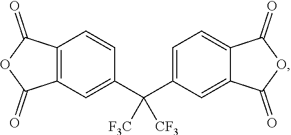 [SMILES: O=C1OC(=O)c2cc(C(c3ccc4c(c3)C(=O)OC4=O)(C(F)(F)F)C(F)(F)F)ccc21]

and a second co-monomer is

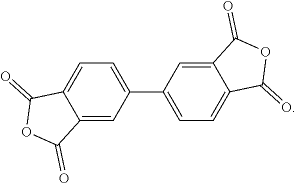 [SMILES: O=C1OC(=O)c2cc(-c3ccc4c(c3)C(=O)OC4=O)ccc21]

Embodiment 18. The polyimide according to embodiment 17, wherein the first monomer and the second monomer are in a molar ratio ranging from 6:5 to 5:6 and the first co-monomer to the second co-monomer is in a molar ratio of 2:1 to 1:1.

Embodiment 19. A polyimide material comprising a polyimide of Formula (III)

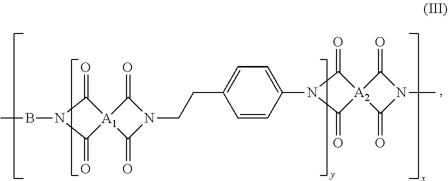

wherein A₁ and A₂ for each occasion independently are selected from a group of tetravalent moieties and B for each occasion independently is selected from a group of divalent moieties, wherein x and Y are integers greater than 1;
wherein the polyimide material has at least one property selected from the following property group M and at least one property selected from the following property group O, wherein property group M includes:
a tensile strength as determined according to ASTM standard D897-08 of at least 2.5 GPa, at least 2.8 GPa, at least 3.0 GPa, at least 3.3 GPa, at least 3.5 GPa, at least 3.8 GPa, at least 4.0 GPa, at least 4.3 GPa, at least 4.5 GPa, at least 4.8 GPa, or at least 5.0 GPa;
a glass transition temperature as determined by thermomechanical analysis of at least 180° C., at least 185° C., at least 190° C., at least 195° C., at least 200° C., at least 205° C., at least 210° C., at least 215° C., at least 220° C., at least 225° C., at least 230° C., at least 235° C., at least 240° C., at least 245° C., at least 250° C., at least 255° C., at least 260° C., at least 265° C., at least 270° C., at least 275° C., at least 280° C., at least 285° C., at least 290° C., at least 295° C., at least 300° C., or at least 305° C.;
a peak molecular weight as determined by size exclusion chromatography against a polystyrene standard of at least 200 kDa, at least 250 kDa, at least 300 kDa, at least 350 kDa, at least 400 kDa, at least 450 kDa, at least 500 kDa, at least 550 kDa, at least 600 kDa, at least 650 kDa, or at least 700 kDa;
an elongation at break of a film having a thickness of 25 micrometer (±5 micrometer) of the polyimide material as determined by ASTM D638-14 of not more than 10%, not more than 9.5%, not more than 9%, not more than 8.5%, not more than 8%, not more than 7.5%, not more than 7%, not more than 6.5%, not more than 6.2%, not more than 6.0%, not more than 5.8%, not more than 5.6%, not more than 5.4%, not more than 5.2%, not more than 5%, or not more than 4.8%;
a folding endurance of a film having a thickness of 25 micrometer (±5 micrometer) of the polyimide material as determined according to ASTM D2176-16 at a radius of 1 mm of at least 10,000 folds, at least 20,000 folds, at least 50,000 folds, at least 80,000 folds, at least 100,000 folds, at least 150,000 folds, at least 180,000 folds, at least 200,000 folds, at least 250,000 folds, at least 300,000 folds, at least 500,000 folds, or at least 1,000,000 folds; and
property group O comprises:
an optical transparency of a film having a thickness of 25 micrometer (±5 micrometer) of the polyimide material as determined by UV-Vis spectroscopy at 400 nm of at least 20%, at least 25%, at least 30%, at least 32%, at least 34%, at least 36%, at least 38%, at least 40%, at least 42%, or at least 44%;
an optical transparency of a film having a thickness of 25 micrometer (±5 micrometer) of the polyimide material as determined by UV-Vis spectroscopy at 550 nm of at least 85%, at least 86%, at least 87%, at least 88%, at least 89%, at least 90%, at least 91%, at least 92%, at least 94%, or at least 96%;
an optical transparency of a film having a thickness of 25 micrometer (±5 micrometer) of the polyimide material of the polyimide material as determined by UV-Vis spectroscopy at 380 nm of not greater than 50%, not greater than 48%, not greater than 46%, not greater than 44%, not greater than 42%, not greater than 40%, not greater than 38%, not greater than 36%, not greater than 34%, not greater than 32%, not greater than 30%, not greater than 28%, not greater than 26%, not greater than 24%, not greater than 22%, not greater than 20%, not greater than 18%, or not greater than 16%;
a thickness retardation Rₜₕ of a film having a thickness of 25 micrometer (±5 micrometer) of the polyimide material of not more than 100 nm, not more than 80 nm, not more than 60 nm, not more than 50 nm, not more than 40 nm, not more than 30 nm, not more than 28 nm, not more than 26 nm, not more than 24 nm, not more than 22 nm, or not more than 20 nm;
a Yellow Index of a film having a thickness of 25 micrometer (±5 micrometer) of the polyimide material according to ASTM E313 of not more than 4.0, not more than 3.5, not more than 3.2, not more than 3.0, not more than 2.8, not more than 2.6, not more than 2.4, not more than 2.2, not more than 2.0, not more than 1.8, not more than 1.6, or not more than 1.4; or
a haze of a film having a thickness of 25 micrometer (±5 micrometer) of the polyimide material as determined according to ASTM D1003-13 of not greater than 1.5%, not greater than 1.3%, not greater than 1.1%, not greater than 1.0%, not greater than 0.8%, not greater than 0.6%, not greater than 0.5%, not greater than 0.4%, or not greater than 0.3%.

Embodiment 20. The polyimide material according to embodiment 19, wherein A₁ or A₂ are selected independently for each occasion from:

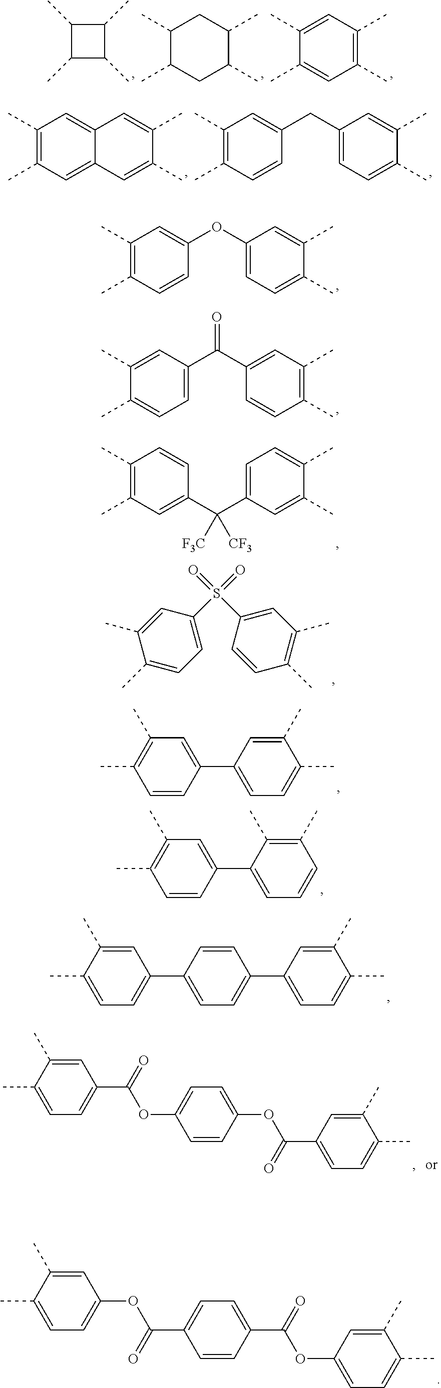

Embodiment 21. The polyimide material according to any one of embodiments 19 and 20, wherein B is selected independently for each occasion from:

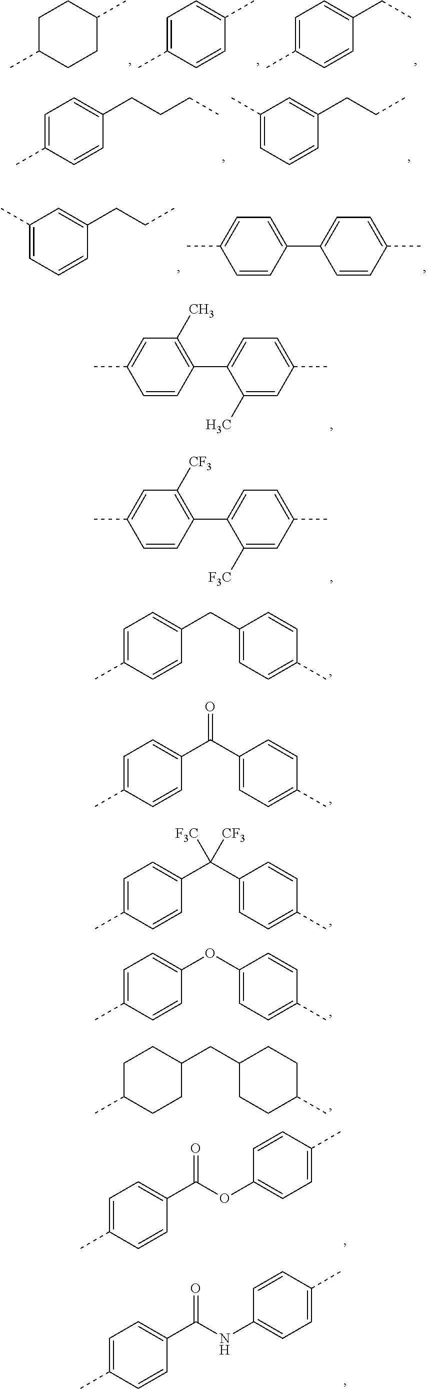

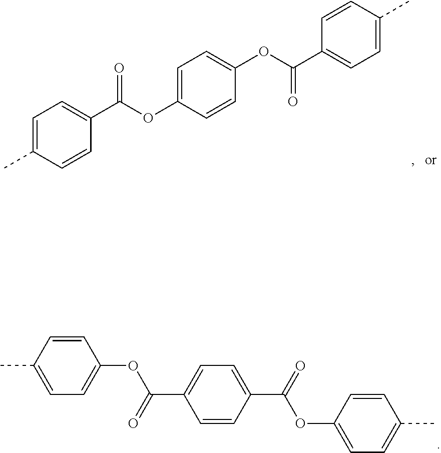

Embodiment 22. The polyimide material according to any one of embodiments 19 through 21 having at least two, at least three, or at least four properties of property group M or having at least two, at least three, or at least four properties of property group O.

Embodiment 23. The polyimide according to any one of embodiments 19 through 21, wherein x and y are in a molar ratio ranging from 10:1 to 1:10, from 5:1 to 1:5, from 3:1 to 1:3, from 2:1 to 1:2, from 3:2 to 2:3, from 4:3 to 3:4, from 5:4 to 4:5, from 6:5 to 5:6, from 7:6 to 6:7, from 8:7 to 7:8, from 9:8 to 8:9, or from 10:9 to 9:10.

The following examples are provided to better disclose and teach processes and compositions of the present invention. They are for illustrative purposes only, and it must be acknowledged that minor variations and changes can be made without materially affecting the spirit and scope of the invention as recited in the claims that follow.

### EXAMPLES

Polyimide material according to the present disclosure can be prepared according to a random type or controlled type procedure. In the random type procedure, all monomers and co-monomers are added to the reaction vessel prior to initiating the reaction. In the controlled type procedure, the reaction is initiated with a limited number of monomers and co-monomers and additional monomers and/or co-monomers are added at a later time.

### Example 1a: Synthesis of Random Type Polyimide at 50 mmol Scale

To a 500 mL 4-neck round bottom flask equipped with an N₂ inlet and outlet, overhead stirrer, and thermocouple, with 100 g m-Cresol, APEA (25 mmol, 3.4050 g) and TFMB (25 mmol, 8.0060 g) was added at room temperature, minimizing APEA exposure to air. Immediately after diamine addition both dianhydrides s-BPDA (20 mmol, 5.8844 g) and 6FDA (30 mmol, 13.3272 g) was added. TFMB, s-BPDA, and 6FDA additions were added into the reactor with m-Cresol as needed to achieve a 15 wt % of all monomers and co-monomers as a final concentration (an additional 73.5 g m-Cresol). A catalytic amount of Isoquinoline (5-10 drops) was added to the reaction vessel. The apparatus was outfitted with a dean-stark trap and condenser and the reaction temperature was increased to 160° C. and held for 4 hours. The reaction was allowed to cool to room temperature and the polymer was recovered via precipitation in methanol. The precipitate was washed three times with methanol and vacuum dried at 160° C. overnight.

### Example 1b: Synthesis of Ordered Type Polyimide at 50 mmol Scale

To a 500 mL 4-neck round bottom flask equipped with an N₂ inlet and outlet, overhead stirrer, and thermocouple, with 73.5 g m-Cresol, s-BPDA (20 mmol, 5.8844 g) and 6FDA (30 mmol, 13.3272 g) was added at room temperature. APEA (25 mmol, 3.4050 g) was added to the reactor, minimizing exposure to air, and heated to 60° C. and held for 1 hour. Finally, TFMB (25 mmol, 8.0060 g) was added to the reactor and the reaction mixture was diluted to a final concentration of 15% by weight of all the reactants (an additional 100 g m-Cresol). A catalytic amount of Isoquinoline (5-10 drops) was added to the reaction. The apparatus was outfitted with a dean-stark trap and condenser and the reaction temperature was raised to 160° C. and held for 4 hours. The reaction was allowed to cool to room temperature and the polymer was recovered via precipitation in methanol. The precipitate was washed three times in methanol, and vacuum dried at 160° C. overnight.

When it comes to the preparation of a polyimide film, a solvent cast approach can be used. Polyimide material can be dissolved in a solvent at a concentration ranging from 10 to 20 weight percent to form a varnish. Solvents can be N,N-dimethylacetamide (DMAc), Cyclopentanone (CPN), Cyclohexanone (CHN), γ-Butyrolactone (GBL), or Acetophenone (PhAc). The varnish can be coated on a flat surface such as a glass plate or a flexible carrier substrate and subsequently be dried. After the initial drying step, the film can be delaminated from the flat surface and further processed.

### Example 2: Preparation of Polyimide Film

Polymer powders isolated from Example 1a and/or 1b were dissolved in DMac at resin loadings of 20% by weight. The resins were mixed, homogenized, and deaerated under minor heating (60° C.) and high shear (2600 rpm) via centrifugal mixing. The resulting polyimide solution was coated via a doctor blade at 15-30 Mils onto borosilicate glass slides in dimensions of 8×4 inches. The film was then dried at 100° C. for 1 hour on a hot plate under atmospheric conditions. After this initial drying step the polyimide film was delaminated from the glass and sandwiched between two metal frames, which is then placed into a vacuum oven and dried at 250° C. overnight under vacuum.

### Example 3: Characterization of Polyimide Films

Polymer films obtained using the methods described in Example 2 were characterized for their optical, thermal and mechanical properties using the following methods:
Film thickness—The thickness of a polyimide film was measured using a Mahr, 2057551 Marameter XLI-57B-15 Portable Thickness Gage. Typically, 6 to 21 measurements were taken across the film and the average value was reported.
Color and Optical Transparency—The optical properties (e.g. percent transmittance, color, haze, Rₜₕ) of a polyimide film was measured using spectrophotometry. The percent transmittance of the polyimide film was measured using a Shimadzu UV-2700 equipped with an integrating sphere (ISR-2600). Typically, films are inserted into a film sample holder and transmittance is measured from 800 nm to 200 nm using a slit width of 5 nm with the transmittance at 380 nm and 400 nm (T_{380%} and T_{400%}) reported. The color and haze of a polyimide film was measured using an X-rite Ci7800 spectrophotometer. Typically, a film sample is placed in a 25 mm sample holder and a Class I continuous wave 532 nm laser is flashed through the sample to measure direct and total transmittance as well as haze. The average of three measurements is reported. The Rₜₕ of a polyimide film was measured using an Axometrics AxoScan™ Mueller Matrix Polarimeter. Typically, the film Rₜₕ is measured by taking two axis out-of-plane retardance measurements at 550 nm wavelength in increments of 10° up to a maximum tilt angle of 50°; several spots are measured per film and the lowest Rₜₕ value is reported.
Thermal properties—Incomplete imidization, residual solvent and thermal stability T_{d} (1%) were assessed using thermogravimetric analysis utilizing a TA Instruments Discovery TGA550. Typically, a few milligrams of polymer film are placed in a TGA pan which is heated at a rate of 10° C./min to 550° C. under a nitrogen purge of 40-60 mL/min. The temperature at which 1% mass loss is achieved is recorded as the T_{d} (1%); for dry films (i.e. fully imidized, no residual solvent) this would typically occur in the 375-450° C. temperature range for these materials. The glass transition (T_{g}) of a polyimide film was measured using dynamic mechanical analysis utilizing a TA Instruments Discovery DMA850 equipped with a film/fiber accessory. Typically, a 5×30 mm sample is die punched and loaded into the film/fiber accessory clamp; the film is heated at 5° C./min rate to 350-400° C. in a nitrogen purged atmosphere under a 0.1% strain oscillated at 1 Hz. The glass transition measurement is determined from the onset of the drop in storage modulus and/or the tan δ maximum. The glass transition and coefficient of thermal expansion (CTE) of a polyimide film was measured using thermal mechanical analysis utilizing a TA Instruments TMA Q400 with a film/fiber accessory. Typically, a 5×30 mm sample is used for testing. The sample is heated at 3° C./min to 350-400° C. under a nitrogen purge of 50 mL/min with a load of 0.5 g per film thickness in um. CTE can be calculated using the slope of the line between 100-200° C. The Tg is calculated by measuring the temperature at which elongation of the sample occurs.
Mechanical properties—The tensile modulus, tensile strength, and elongation at break were measured using an Instron 5967 with a 500 N load cell. Typically, the specimens are tested following ASTM 1708. The sample dimensions follow those listed in ASTM 1708 and thickness is measured for each film utilizing a Mahr GmbH 1086Ri 25/0,0005 mm (1″/0.00002″). Measured force and sample displacement are used by the Instron to calculate the modulus, tensile strength, and elongation at break.

TABLE 1
Optical properties for films generated from Example 1a and/or 1b.

| | | | | | | | |
|---|---|---|---|---|---|---|---|
| | Film | | | | | | |
| | Thickness | | Haze | | | | |
| Film ID | (μm) | YI | (%) | % TMax | 1% T | T380% | T400% |

Prepared according to Experiment 1a

| | | | | | | | |
|---|---|---|---|---|---|---|---|
| A1 | 39.5 | 8.4 | 0.03 | 90.8 | 381 | 0.8 | 34.3 |
| A2 | 43 | 4.4 | 0.12 | 89.8 | 380 | 1.3 | 40.4 |
| A3 | 45 | 4.7 | 0.02 | 89.9 | 382 | 0.6 | 34.6 |
| A4 | 29 | 3.8 | 0.71 | 90.7 | 378 | 2.5 | 46.8 |
| A5 | 32 | 8.3 | 0.23 | 90.8 | 380 | 1.3 | 37.5 |
| A6 | 42.8 | 5.2 | 0.54 | 91.5 | 382 | 0.6 | 35.7 |

Prepared according to Example 1b

| | | | | | | | |
|---|---|---|---|---|---|---|---|
| B1 | 22.5 | 3.6 | 0.5 | 90.3 | 377 | 3.2 | 48.8 |
| B2 | 21.5 | 3.4 | — | 90.3 | 376 | 4.2 | 51.1 |
| B3 | 33.5 | 4.6 | — | 89.7 | 381 | 0.9 | 37.4 |
| B4 | 19.5 | 3.1 | — | 90.78 | 374 | 5.6 | 53.8 |
| B5 | 20 | 3.1 | — | 90.8 | 374 | 5.5 | 53.6 |
| B6 | 24 | 3.7 | — | 90.3 | 377 | 3.1 | 48.1 |
| B7 | 24.5 | 3.8 | — | 90.7 | 378 | 2.5 | 46.5 |
| B8 | 29.5 | 4.0 | 0.25 | 90.830 | 380 | 1.274 | 41.322 |
| B9 | 28 | 3.7 | 0.83 | 90.568 | 378 | 2.472 | 47.003 |
| B10 | 32.5 | 4.0 | 0.54 | 90.641 | 379 | 1.536 | 42.967 |
| B11 | 34 | 4.1 | 0.63 | 90.591 | 381 | 0.967 | 38.8 |

*YI calculated from UV/Vis spectra

TABLE 2
Thermal and mechanical properties of films generated from
Examples 1a and/or 1b.

| | | | | | |
|---|---|---|---|---|---|
| | | Residual | Tensile | | |
| Film | Film | Solvent | Modulus | σₘₐₓ | |
| ID | Thickness | (%) | (GPa) | (MPa) | ε_{break} |

Prepared according to Example 1a

| | | | | | |
|---|---|---|---|---|---|
| A1 | 39.21 | 0.95 | 4.00 +/− 0.05 | 122.600 | 8 +/− 5 |
| A2 | 42.55 | 0 | 3.8 +/− 0.2 | 120.064 | 8 +/− 3 |
| A3 | 44.88 | 0 | 3.85 +/− 0.06 | 120.259 | 7 +/− 1 |
| A4 | 28.59 | 0.00 | 4.11 +/− 0.07 | 129.786 | 10 +/− 9 |
| A5 | 32.5 | 0.51 | 3.9 +/− 0.3 | 123.220 | 10 +/− 4 |
| A6 | 42.42 | 0.40 | 4.1 +/− 0.1 | 124.470 | 6 +/− 1 |

Prepared according to Example 1b

| | | | | | |
|---|---|---|---|---|---|
| B1 | 22.64 | 0.40 | 4.5 +/− 0.1 | 137.3 | 7 +/− 3 |
| B2 | 21.36 | 0.47 | 4.58 +/− 0.08 | 139.8 | 20 +/− 10 |
| B3 | 32.9 | 1.09 | 4.44 +/− 0.08 | 136.8 | 7 +/− 3 |
| B4 | 19.55 | 0.44 | 4.56 +/− 0.09 | 135.8 | 8 +/− 3 |
| B5 | 19.79 | 0.37 | 4.51 +/− 0.09 | 134.9 | 8 +/− 6 |
| B6 | 23.93 | 1.97 | 4.60 +/− 0.11 | 141.5 | 9 +/− 7 |
| B7 | 24.24 | 0.36 | 4.5 +/− 0.1 | 133.6 | 5 +/− 1 |
| B8 | 29.93 | 0.78 | 4.39 +/− 0.07 | 136.0 | 7 +/− 3 |
| B9 | 27.78 | 0.33 | 4.5 +/− 0.1 | 138.5 | 10 +/− 4 |
| B10 | 32.4 | 0.40 | 4.5 +/− 0.1 | 142.8 | 8 +/− 2 |
| B11 | 34.52 | 0.47 | 4.4 +/− 0.1 | 137.7 | /− 3 |

Note that not all of the activities described above in the general description or the examples are required, that a portion of a specific activity may not be required, and that one or more further activities may be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

1. A polyimide material comprising a polyimide of Formula (I) 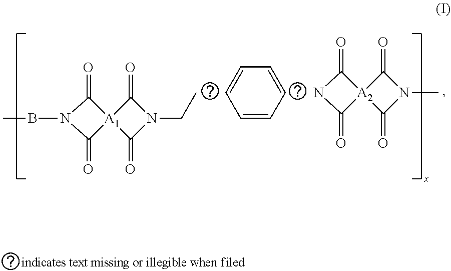
wherein A₁ and A₂ for each occasion independently are selected from a group of tetravalent moieties and B for each occasion independently is selected from a group of divalent moieties, wherein x is an integer greater than 1;
wherein the polyimide material has at least one property selected from the following property group M and at least one property selected from the following property group O, wherein property group M comprises:
(i) a tensile strength of the polyimide material as determined according to ASTM standard D897-08 of at least 2.5 GPa, at least 2.8 GPa, at least 3.0 GPa, at least 3.3 GPa, at least 3.5 GPa, at least 3.8 GPa, at least 4.0 GPa, at least 4.3 GPa, at least 4.5 GPa, at least 4.8 GPa, or at least 5.0 GPa;
(ii) a glass transition temperature of the polyimide material as determined by thermomechanical analysis of at least 180° C., at least 185° C., at least 190° C., at least 195° C., at least 200° C., at least 205° C., at least 210° C., at least 215° C., at least 220° C., at least 225° C., at least 230° C., at least 235° C., at least 240° C., at least 245° C., at least 250° C., at least 255° C., at least 260° C., at least 265° C., at least 270° C., at least 275° C., at least 280° C., at least 285° C., at least 290° C., at least 295° C., at least 300° C., or at least 305° C.;
(iii) a peak molecular weight as determined by size exclusion chromatography against a polystyrene standard of at least 200 kDa, at least 250 kDa, at least 300 kDa, at least 350 kDa, at least 400 kDa, at least 450 kDa, at least 500 kDa, at least 550 kDa, at least 600 kDa, at least 650 kDa, or at least 700 kDa;
(iv) an elongation at break of a film having a thickness of 25 micrometer (±5 micrometer) of the polyimide material as determined by ASTM D638-14 of not more than 10%, not more than 9.5%, not more than 9%, not more than 8.5%, not more than 8%, not more than 7.5%, not more than 7%, not more than 6.5%, not more than 6.2%, not more than 6.0%, not more than 5.8%, not more than 5.6%, not more than 5.4%, not more than 5.2%, not more than 5%, or not more than 4.8%; or
(v) a folding endurance of a film having a thickness of 25 micrometer (±5 micrometer) of the polyimide material as determined according to ASTM D2176-16 over a pin having a radius of 1 mm of at least 10,000 folds, at least 20,000 folds, at least 50,000 folds, at least 80,000 folds, at least 100,000 folds, at least 150,000 folds, at least 180,000 folds, at least 200,000 folds, at least 250,000 folds, at least 300,000 folds, at least 500,000 folds, or at least 1,000,000 folds; and property group O comprises:
(i) an optical transparency of a film having a thickness of 25 micrometer (±5 micrometer) of the polyimide material as determined by UV-Vis spectroscopy at 400 nm of at least 20%, at least 25%, at least 30%, at least 32%, at least 34%, at least 36%, at least 38%, at least 40%, at least 42%, or at least 44%;
(ii) an optical transparency of a film having a thickness of 25 micrometer (±5 micrometer) of the polyimide material as determined by UV-Vis spectroscopy at 550 nm of at least 85%, at least 86%, at least 87%, at least 88%, at least 89%, at least 90%, at least 91%, at least 92%, at least 94%, or at least 96%;
(iii) an optical transparency of a film having a thickness of 25 micrometer (±5 micrometer) of the polyimide material as determined by UV-Vis spectroscopy at 330 nm of not greater than 50%, not greater than 48%, not greater than 46%, not greater than 44%, not greater than 42%, not greater than 40%, not greater than 38%, not greater than 36%, not greater than 34%, not greater than 32%, not greater than 30%, not greater than 28%, not greater than 26%, not greater than 24%, not greater than 22%, not greater than 20%, not greater than 18%, or not greater than 16%;
(iv) a thickness retardation Rₜₕ of not more than 100 nm, not more than 80 nm, not more than 60 nm, not more than 50 nm, not more than 40 nm, not more than 30 nm, not more than 28 nm, not more than 26 nm, not more than 24 nm, not more than 22 nm, or not more than 20 nm;
(v) a Yellow Index according to ASTM E313 of a film having a thickness of 25 micrometer (±5 micrometer) of the polyimide material of not more than 4.0, not more than 3.5, not more than 3.2, not more than 3.0, not more than 2.8, not more than 2.6, not more than 2.4, not more than 2.2, not more than 2.0, not more than 1.8, not more than 1.6, or not more than 1.4; or
(vi) a haze as determined according to ASTM D1003-13 of a film having a thickness of 25 micrometer (±5 micrometer) of the polyimide material of not greater than 1.5%, not greater than 1.3%, not greater than 1.1%, not greater than 1.0%, not greater than 0.8%, not greater than 0.6%, not greater than 0.5%, not greater than 0.4%, or not greater than 0.3%.

2. The polyimide material according to claim 1, wherein A₁ or A₂ are selected independently for each occasion from:

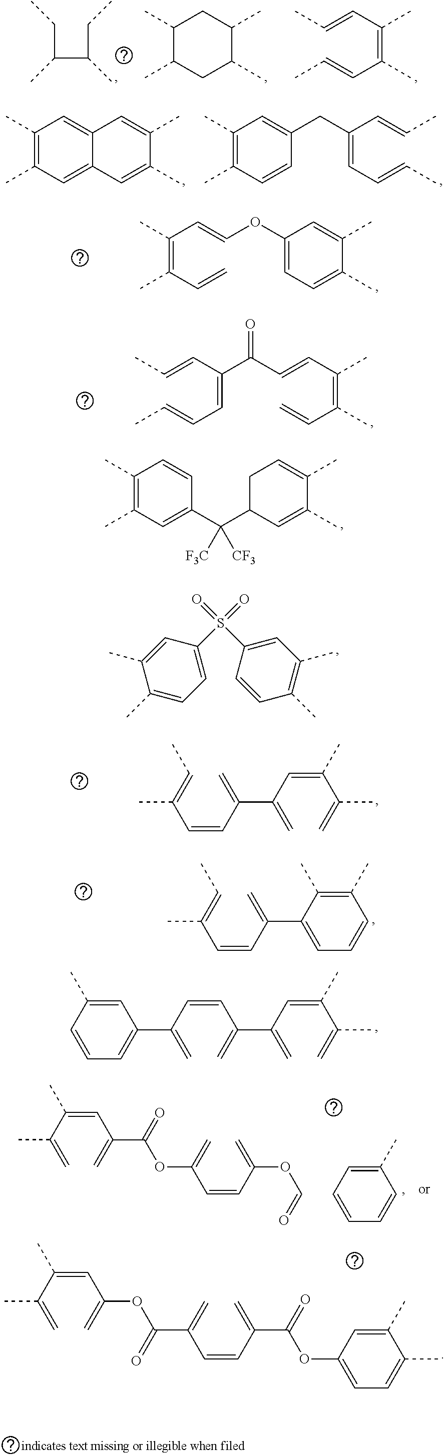

3. The polyimide material according to claim 2, wherein A₁ or A₂ are selected independently for each occasion from the group consisting essentially of:

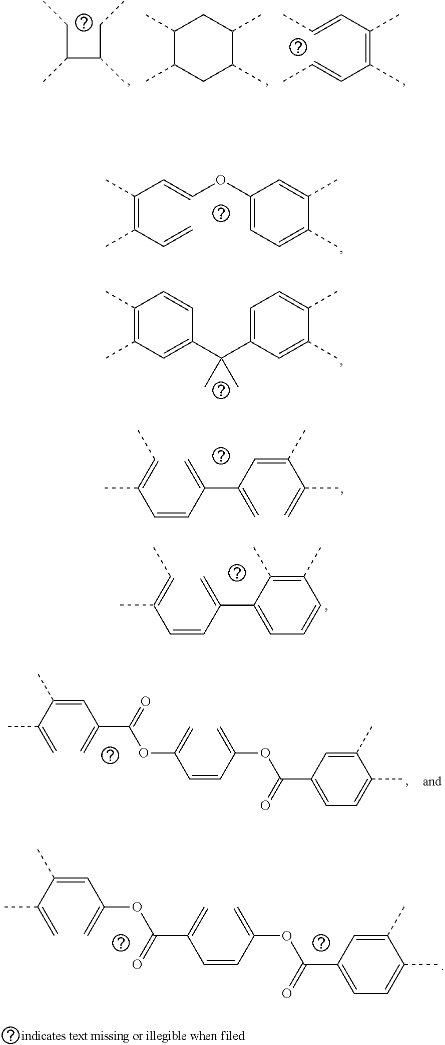

4. The polyimide material according to claim 1, wherein A₁ or A₂ are selected independently for each occasion from the group consisting of:

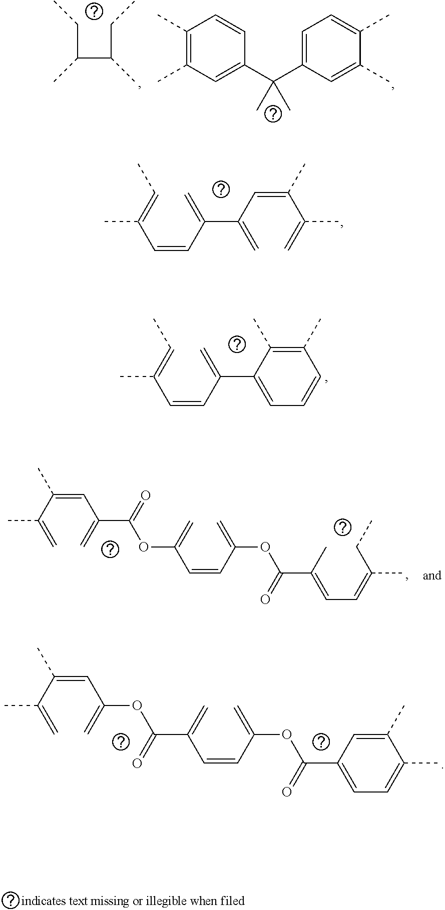

5. The polyimide material according to claim 1, wherein B is selected independently for each occasion from:

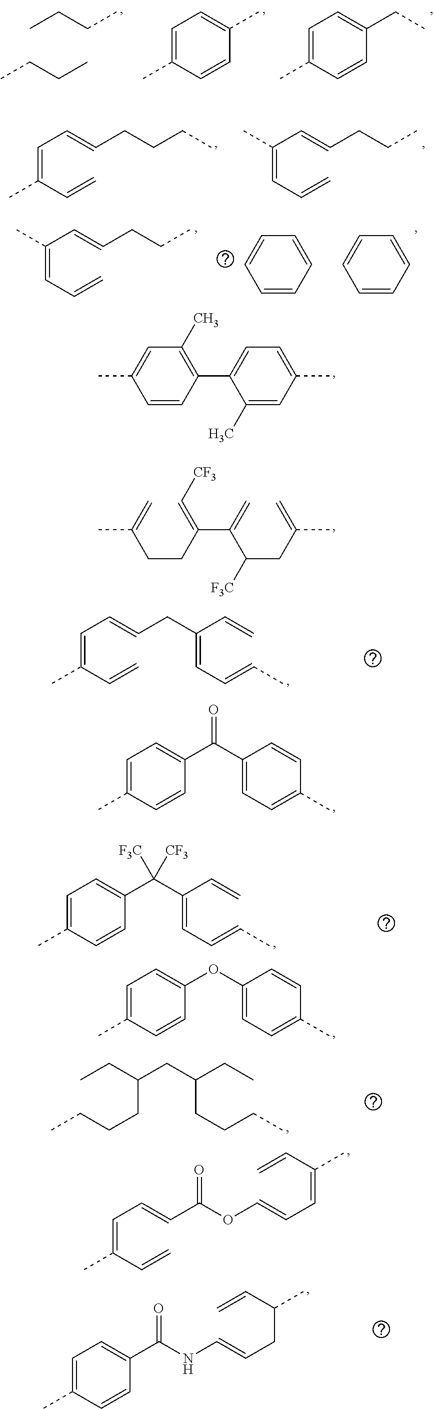

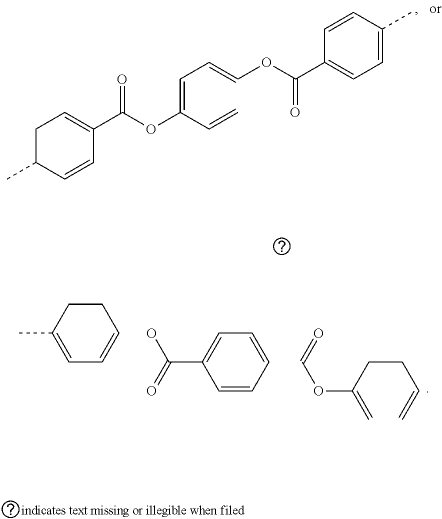

6. The polyimide material according to claim 1 wherein B is selected independently for each occasion from the group consisting of:

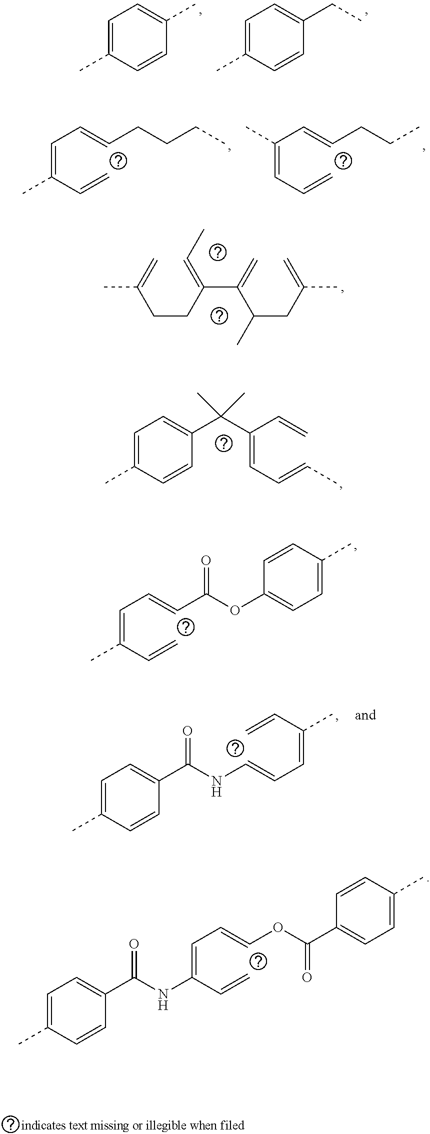

7. The polyimide material according to claim 1 having at least two, at least three, or at least four properties of property group M.

8. The polyimide material according to claim 1 having at least two, at least three, or at least four properties of property group O.

9. An optical stack comprising a polyimide material according to claim 1.

10. An electronic device comprising a polyimide material according to claim 1.

11. A polyimide made from a first monomer comprising Formula (II): 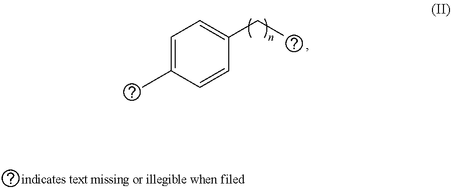
wherein n is 1, 2, or 3; and at least one second monomer selected from the group consisting of 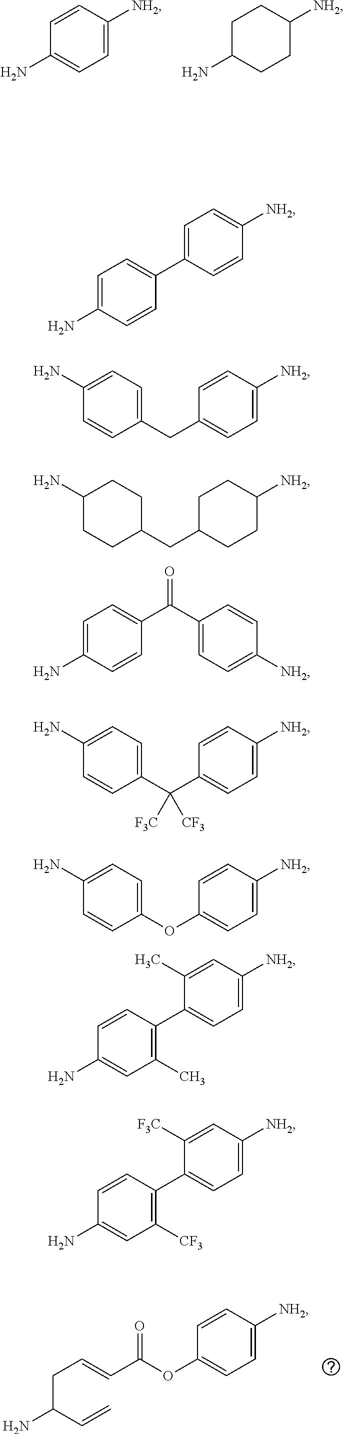 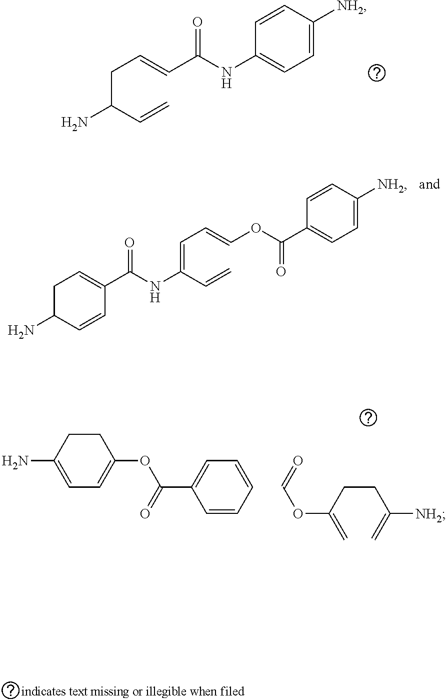
and
at least one co-monomer selected from the group consisting of:

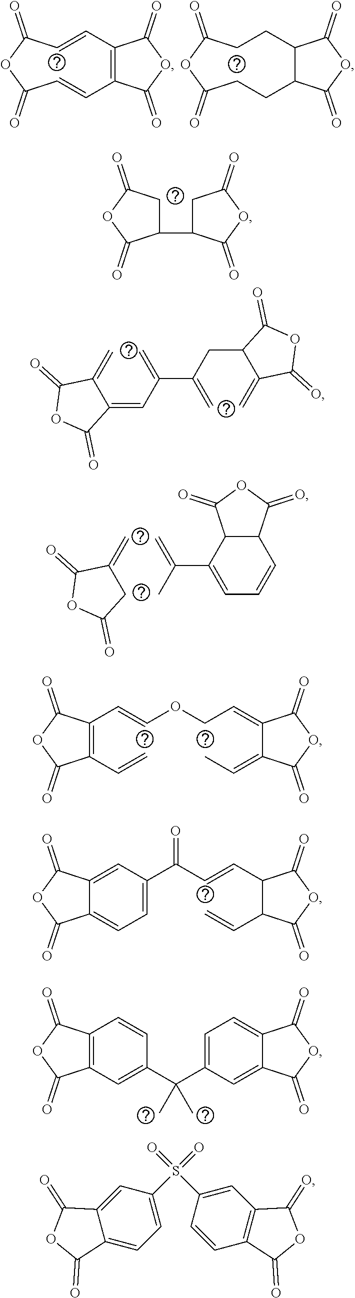

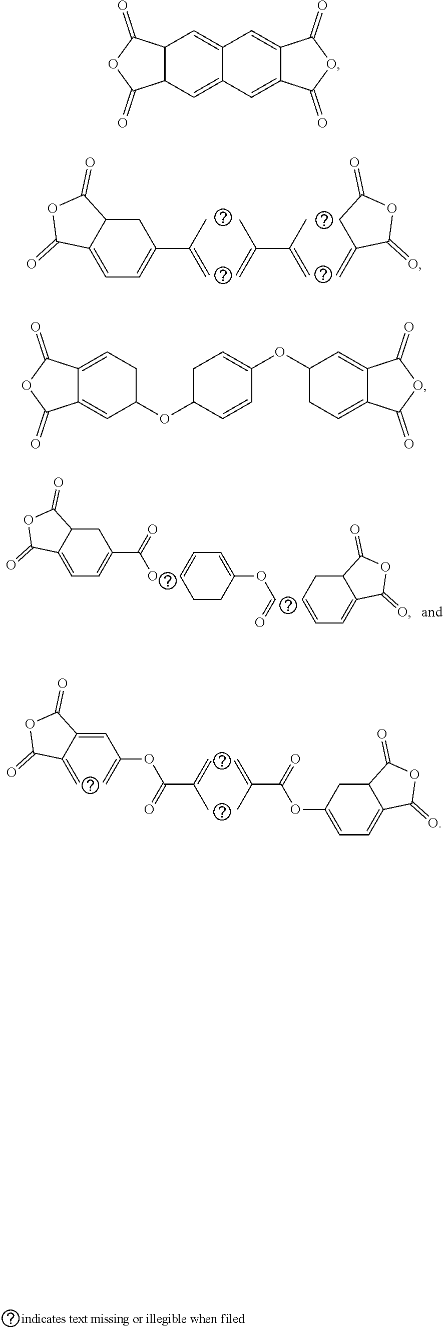

12. The polyimide according to claim 11, wherein the first and the second monomer are in a molar ratio ranging from 10:1 to 1:10, from 5:1 to 1:5, from 3:1 to 1:3, from 2:1 to 1:2, from 3:2 to 2:3, from 4:3 to 3:4, from 5:4 to 4:5, from 6:5 to 5:6, from 7:6 to 6:7, from 8:7 to 7:8, from 9:8 to 8:9, or from 10:9 to 9:10.

13. The polyimide according to claim 11, made from at least two co-monomers.

14. The polyimide according to claim 11, wherein the first monomer is

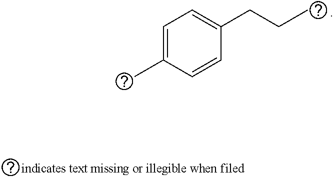

15. The polyimide according to claim 11, comprising at least two co-monomers, wherein the two co-monomers are selected from

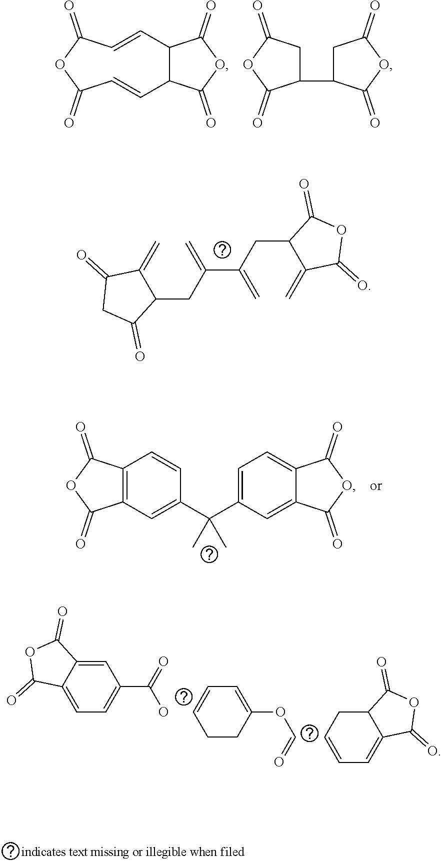

16. The polyimide according to claim 15, wherein the two co-monomers are in a molar ratio ranging from 10:1 to 1:10, from 5:1 to 1:5, from 3:1 to 1:3, from 2:1 to 1:2, from 3:2 to 2:3, from 4:3 to 3:4, from 5:4 to 4:5, from 6:5 to 5:6, from 7:6 to 6:7, from 8:7 to 7:8, from 9:8 to 8:9, or from 10:9 to 9:10.

17. The polyimide according to claim 11, wherein the first monomer is 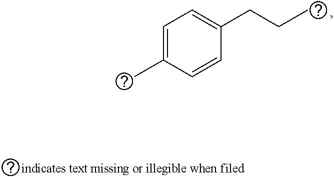
the second monomer is 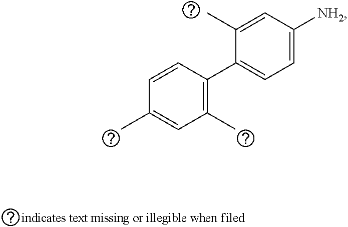 [SMILES: Cc1ccc(-c2ccc(N)cc2C)c(C)c1]
a first co-monomer is 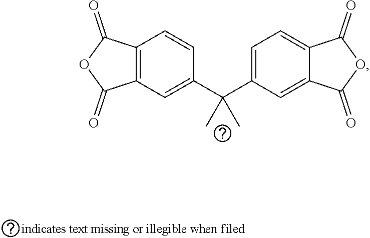 [SMILES: CC(C)(c1ccc2c(c1)C(=O)OC2=O)c1ccc2c(c1)C(=O)OC2=O]
and a second co-monomer is

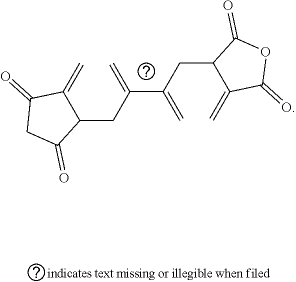 [SMILES: C=C(CC1C(=C)C(=O)CC1=O)C(=C)CC1C(=C)C(=O)OC1=O]

18. The polyimide according to claim 17, wherein the first monomer and the second monomer are in a molar ratio ranging from 6:5 to 5:6 and the first co-monomer to the second co-monomer is in a molar ratio of 2:1 to 1:1.

19. A polyimide material comprising a polyimide of Formula (III) 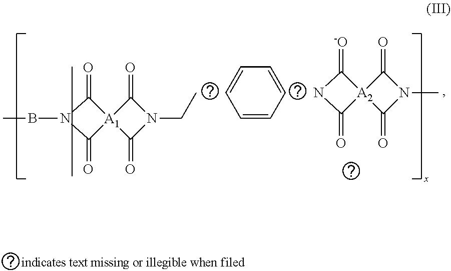
wherein A₁ and A₂ for each occasion independently are selected from a group of tetravalent moieties and B for each occasion independently is selected from a group of divalent moieties, wherein x and Y are integers greater than 1;
wherein the polyimide material has at least one property selected from the following property group M and at least one property selected from the following property group O, wherein property group M comprises:
(i) a tensile strength as determined according to ASTM standard D897-08 of at least 2.5 GPa, at least 2.8 GPa, at least 3.0 GPa, at least 3.3 GPa, at least 3.5 GPa, at least 3.8 GPa, at least 4.0 GPa, at least 4.3 GPa, at least 4.5 GPa, at least 4.8 GPa, or at least 5.0 GPa;
(ii) a glass transition temperature as determined by thermomechanical analysis of at least 180° C., at least 185° C., at least 190° C., at least 195° C., at least 200° C., at least 205° C., at least 210° C., at least 215° C., at least 220° C., at least 225° C., at least 230° C., at least 235° C., at least 240° C., at least 245° C., at least 250° C., at least 255° C., at least 260° C., at least 265° C., at least 270° C., at least 275° C., at least 280° C., at least 285° C., at least 290° C., at least 295° C., at least 300° C., or at least 305° C.;
(iii) a peak molecular weight as determined by size exclusion chromatography against a polystyrene standard of at least 200 kDa, at least 250 kDa, at least 300 kDa, at least 350 kDa, at least 400 kDa, at least 450 kDa, at least 500 kDa, at least 550 kDa, at least 600 kDa, at least 650 kDa, or at least 700 kDa;
(iv) an elongation at break of a film having a thickness of 25 micrometer (±5 micrometer) of the polyimide material as determined by ASTM D638-14 of not more than 10%, not more than 9.5%, not more than 9%, not more than 8.5%, not more than 8%, not more than 7.5%, not more than 7%, not more than 6.5%, not more than 6.2%, not more than 6.0%, not more than 5.8%, not more than 5.6%, not more than 5.4%, not more than 5.2%, not more than 5%, or not more than 4.8%;
(v) a folding endurance of a film having a thickness of 25 micrometer (±5 micrometer) of the polyimide material as determined according to ASTM D2176-16 at a radius of 1 mm of at least 10,000 folds, at least 20,000 folds, at least 50,000 folds, at least 80,000 folds, at least 100,000 folds, at least 150,000 folds, at least 180,000 folds, at least 200,000 folds, at least 250,000 folds, at least 300,000 folds, at least 500,000 folds, or at least 1,000,000 folds; and
property group O comprises:
(i) an optical transparency of a film having a thickness of 25 micrometer (±5 micrometer) of the polyimide material as determined by UV-Vis spectroscopy at 400 nm of at least 20%, at least 25%, at least 30%, at least 32%, at least 34%, at least 36%, at least 38%, at least 40%, at least 42%, or at least 44%;
(ii) an optical transparency of a film having a thickness of 25 micrometer (±5 micrometer) of the polyimide material as determined by UV-Vis spectroscopy at 550 nm of at least 85%, at least 86%, at least 87%, at least 88%, at least 89%, at least 90%, at least 91%, at least 92%, at least 94%, or at least 96%;
(iii) an optical transparency of a film having a thickness of 25 micrometer (±5 micrometer) of the polyimide material of the polyimide material as determined by UV-Vis spectroscopy at 380 nm of not greater than 50%, not greater than 48%, not greater than 46%, not greater than 44%, not greater than 42%, not greater than 40%, not greater than 38%, not greater than 36%, not greater than 34%, not greater than 32%, not greater than 30%, not greater than 28%, not greater than 26%, not greater than 24%, not greater than 22%, not greater than 20%, not greater than 18%, or not greater than 16%;
(iv) a thickness retardation Rₜₕ of a film having a thickness of 25 micrometer (±5 micrometer) of the polyimide material of not more than 100 nm, not more than 80 nm, not more than 60 nm, not more than 50 nm, not more than 40 nm, not more than 30 nm, not more than 28 nm, not more than 26 nm, not more than 24 nm, not more than 22 nm, or not more than 20 nm;
(v) a Yellow Index of a film having a thickness of 25 micrometer (±5 micrometer) of the polyimide material according to ASTM E313 of not more than 4.0, not more than 3.5, not more than 3.2, not more than 3.0, not more than 2.8, not more than 2.6, not more than 2.4, not more than 2.2, not more than 2.0, not more than 1.8, not more than 1.6, or not more than 1.4; or
(vi) a haze of a film having a thickness of 25 micrometer (±5 micrometer) of the polyimide material as determined according to ASTM D1003-13 of not greater than 1.5%, not greater than 1.3%, not greater than 1.1%, not greater than 1.0%, not greater than 0.8%, not greater than 0.6%, not greater than 0.5%, not greater than 0.4%, or not greater than 0.3%.

20. The polyimide material according to claim 19, wherein A₁ or A₂ are selected independently for each occasion from:

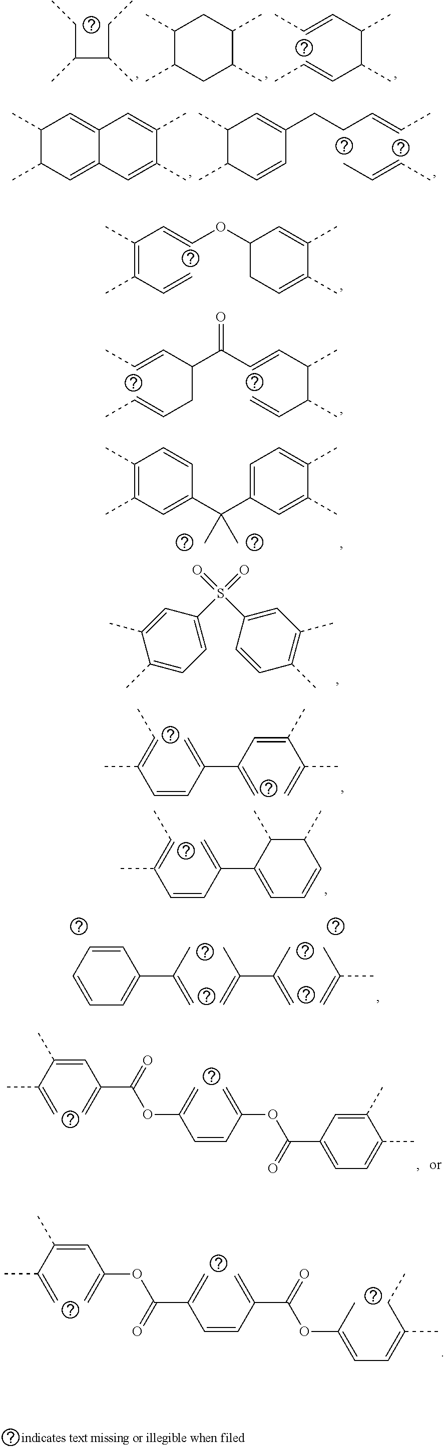

21. The polyimide material according to claim 19 wherein B is selected independently for each occasion from:

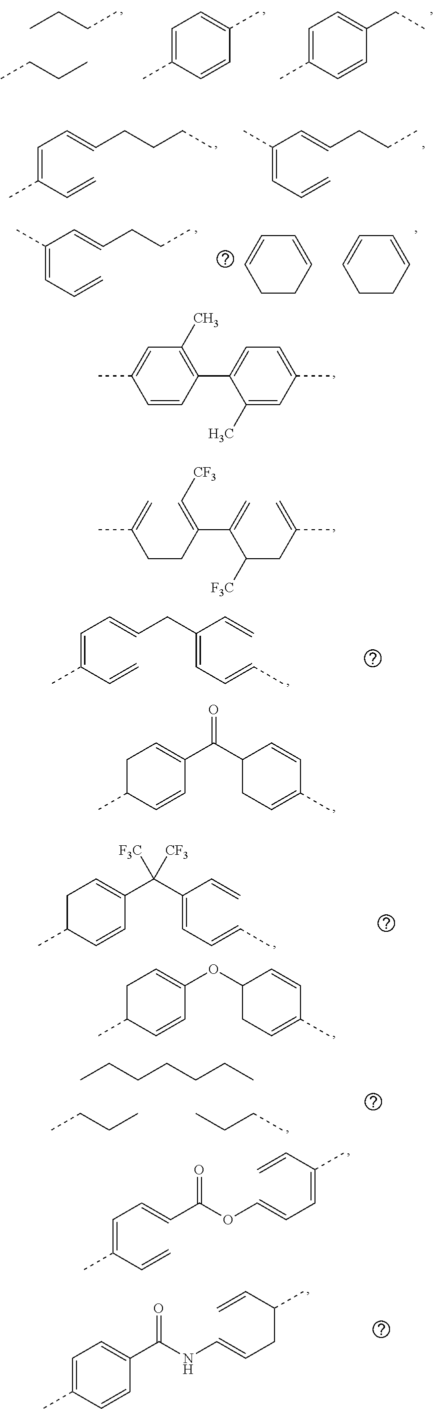

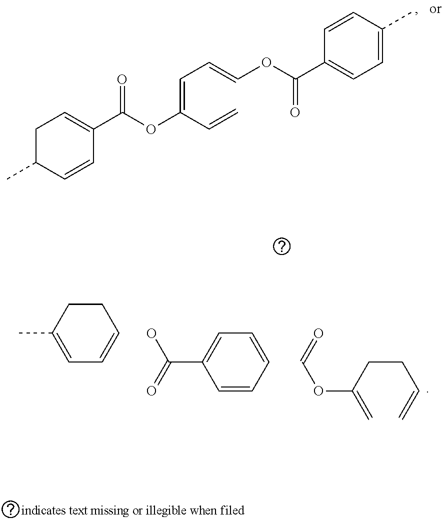

22. The polyimide material according to claim 19, having at least two, at least three, or at least four properties of property group M or having at least two, at least three, or at least four properties of property group O.

23. The polyimide according to claim 19, wherein x and y are in a molar ratio ranging from 10:1 to 1:10, from 5:1 to 1:5, from 3:1 to 1:3, from 2:1 to 1:2, from 3:2 to 2:3, from 4:3 to 3:4, from 5:4 to 4:5, from 6:5 to 5:6, from 7:6 to 6:7, from 8:7 to 7:8, from 9:8 to 8:9, or from 10:9 to 9:10.
